(19) United States
(12) Patent Application Publication
(10) Pub. No.: US 2019/0042644 A1
(43) Pub. Date: Feb. 7, 2019

(54) METHOD AND SYSTEM FOR ADDING EBOOK ASSOCIATIONS, TEXT AND SEGMENTS WITHIN TWO OR MORE DISTINCT EBOOKS OF DIGITALLY STORED LITERATURE

(71) Applicant: LISA QUINTANA, SANTA CRUZ, CA (US)

(72) Inventor: LISA QUINTANA, SANTA CRUZ, CA (US)

(21) Appl. No.: 15/882,150

(22) Filed: Jan. 29, 2018

Related U.S. Application Data
(63) Continuation-in-part of application No. 15/056,029, filed on Feb. 29, 2016.
Application No. 15/056,029 is a continuation-in-part of application No. 13/725,977, filed on Dec. 21, 2012, now Pat. No. 9,760,545.
Application No. 13/725,977 is a continuation-in-part of application No. 15/424,535, filed on Feb. 3, 2017.

(51) Int. Cl. G06F 17/30; G06F 17/24

(52) U.S. Cl. CPC G06F 17/30716; G06F 17/24; G06F 17/30873; G06F 17/30722

(57) ABSTRACT

A method and system are presented whereby the metadata describing segments of one or more digitized texts and the descriptors thereof may be inserted into the digitized text and edited by a human editor. The metadata may optionally describe the relationships between human-generated segments of a source text and the tags used to describe aspects of the segments, wherein the tags may describe narrative themes, places, characters, etc., and/or the relationships between the segments of text, the tags describing the segments of text, and data structures used to compare relationships between the tags on various segments of text (“nodes”). The text segments, narrative tags, and/or nodes may be associated across one or more ebooks, wherein the one or more ebooks are optionally placed within a collection having a collective metadata. When the text segments, the narrative tags and/or the nodes within and describing the one or more texts are edited, the associated individual or collective metadata is adjusted accordingly.

### CO-PENDING PATENT APPLICATION

This Nonprovisional Patent Application is a Continuation-in-Part Application to Nonprovisional patent application Ser. No. 15/056,029 as filed on Feb. 29, 2016 by Inventor Lisa Quintana and titled METHOD AND SYSTEM FOR ASSOCIATING TEXT AND SEGMENTS WITHIN MULTI-TAGGED LITERATURE BY APPLICATION OF METADATA.

This Nonprovisional Patent Application is a Continuation-in-Part Application to Nonprovisional patent application Ser. No. 15/424,535 as filed on Feb. 3, 2017 by Inventor Lisa Quintana and titled METHOD AND SYSTEM FOR ASSOCIATING TEXT AND SEGMENTS WITHIN MULTI-TAGGED LITERATURE BY APPLICATION OF METADATA.

### FIELD OF THE INVENTION

The present invention relates to the generation, parsing, modification, structure and structuring of electronically stored digitized text. More particularly, the present invention relates to digitized textual documents and methods and devices for organizing, rendering and experiencing segments within a digitized text or across multiple and distinguishable digitized documents, of either a newly generated or a previously authored document, and the methods by which the metadata describing the documents, the relationships between the documents, and organization thereof may be described.

### BACKGROUND OF THE INVENTION

The market for and supply channels of digitized copies of textual documents, or “ebooks”, is presently well established in both domestic and international channels of commerce. Yet the prior art merely offers essential access to each ebook by presenting a single narrative line in simulation of the typical method of reading a hard copy text from front page to last page. While prior art ebook readers do allow a reader to (a.) record electronic bookmarks within an ebook, (b.) peruse an ebook on the basis of page number or key word selection, (c.) jump from page to page, and (d.) activate hyperlinks to move from one point to another point within an ebook, the prior art wholly fails to optimize the possibilities of offering two or more alternate narrative threads through a same ebook, and to provide efficient means by which the narrative threads and segments of the narrative may be organized by means of metadata tags. The prior art additionally fails to provide an optimal means by which narrative threads may be established through two or more books by means of narrative and metadata tags.

There is therefore a long felt need to provide a method and device to establish two or more threads of separately associated segments which a reader may selectively follow while accessing an ebook, or two or more related ebooks.

### SUMMARY OF THE INVENTION

Toward this and other objects that are made obvious in light of the disclosure, a method and system are provided for separating one or more digitized textual documents into a plurality of textual segments, wherein each textual segment (hereinafter, “segments”) may be associated with one or more unique tags. One or more pluralities of segments may be associated with unique tags, wherein a first plurality of segments may be defined by associating each segment of the first plurality of segments with a first tag, and additional pluralities of segments are each defined by associating each segment of the particular plurality of segments with a unique and distinguishable tag. For example, a subset of segments of one or more source documents may be selected out and each associated with a particular character. This exemplary subset of segments may, in an exemplary but not limited method, be associated with a common tag that represents an association with this particular character across, for example, several books comprising a series.

Additionally and optionally the segments may be further assigned sequence numbers that order each segment along a one-dimensional order wherein no two sequence numbers are equal, i.e., in a comparison of any two sequence numbers one sequence number will indicate an earlier relative position of the associated segment within the sequence of segments and the other sequence number of the other segment will indicate a later relative position within the sequence of segments.

Segments may be associated with tags that include various literary qualities and aspects, such as, but not limited to, one or more characters, narrators, points of view, scenes, moments in time, locales, themes, object, and/or other suitable literary aspects or qualities.

It is understood that the digitized textual documents may be a digitized representation of a previously written text, e.g., “Ulysses” by James Joyce, or may be a newly authored work that is separated into segments and organized with two or more distinguishable pluralities of uniquely and differently tagged segments.

Two or more segments may include references to scenes and time line moments, wherein two or more segments may be associated with a same scene at a same time line moments, but might also each be disparately associated with different aspects of the source text, such as point of view, character or theme. Alternately or additionally, two or more segments may be associated with two or more different aspects of the source text(s).

When the segments are stored as segments records and tags are associated with at least two or more segments records, one or more software nodes may be instantiated at run time and/or stored within node records in electronic memory. Nodes are data structures that are associated with at least one segment record and are applied, among other uses, to determine when two segments are associated with a same tag. For example, when two segments are each separately associated with a different character but are also tagged as being related to a same scene in a plot timeline, a node may be generated that comprises references to the scene, to both characters, and to the two segments.

According to a second aspect of the method of the present invention (hereinafter, the “invented method”), an editing system comprising an editor software is provided that enables a human editor to define and populate segment records and separate source textual documents into segments having different tags or different combinations of tags.

According to a third aspect of the invented method, an ebook rendering device (hereinafter, the “ebook device”) comprising a reader software is provided that enables a human reader to select a thread of segments wherein each segment of a selected thread is associated with a same tag. The ebook device may be directed by the human reader to (a.) sequentially render each segment of a selected thread; (b.) selectively render two or more segments associated with a same node; (c.) select which tag from a plurality of tags to follow in order to sequentially render segments in accordance with a predefined thread of segments; and/or (d.) enable a human reader to select or input an aspect of the textual document to apply to the pluralities of segments and select a plurality of segments on the criterion of association with the selected or input aspect of the digitized document. The selected or input aspect of the digitized document might be a character, a setting, a reference to a point within a timeline, a theme, a locale, a dialogue, and/or or a literary quality.

According to a fourth aspect of the invented method, one or more segments might be associated with more than one tag, and some or all of the text of a segment might also be comprised within an additional segment or segment record.

According to a fifth aspect of the invented method, a software structure is established wherein a plurality of nodes are interrelated and each segment is associated with at least one node. The nodes may be generated in a compilation or execution performed in light of the associations of the segments and may optionally or alternately generated at a runtime of a software program.

Optionally or additionally one or more nodes may be linked to or associated with two or more associated segments. For example, a node may enable a fictional same scene in a novel to be explicated from both (a.) a first point of view of a narrator, and (b.) a second point of view of a character who is portrayed as being present within the same scene. The invented ebook reader device may optionally enable the human reader to access two or more segments that are with a same node wherein these segments may be further associated with different tags, e.g., character tags. For example, the human reader may enjoy perusing the different points of view of different characters related to a same scene and within the general plot line or narrative of the source digitized textual documents.

According to a fifth optional aspect of the invented method, a non-transitory computer-readable medium is provided that enables the ebook device to render segments in accordance with one or more aspects of the invented method.

Additionally, a method is provided by which the one or more source texts may be entered into the memory of the editing system, generating a plurality of segments from the source texts.

The segments of the source texts may be associated by a human editor with at least one of a plurality of navigation tags and at least one of a plurality of the nodes. Additionally metadata is generated, wherein the metadata identifies the segments and at least one of the associated tag and/or at least one node. Metadata, as understood in the art, is a form of data that acts as a descriptor for other forms of data, allowing for easier perusal of data by editing systems. The metadata indicating connections between segments and tags and/or nodes may be input or edited by a human editor, and may be adjusted based upon adjustments to the segments and/or the tags and/or the nodes.

Additionally presented is a means by which segments are created, and metadata tags are assigned to the segments of digitized text after the entering of one or more digitized texts into an ebook system, but prior to the generation of an ebook, or several ebooks. According to this preferred embodiment, a segment within a first ebook may be associated in a narrative thread to a segment in a separate ebook, and the metadata of each ebook is updated to reflect the association of the segment in the first ebook to the segment of the second ebook.

In a yet additional preferred embodiment, a plurality of ebooks may be generated from a single source digitized text, and the plurality of ebooks generated from the single source digitized text may be associated to one another by means of a “collection.” In the present preferred embodiment, the associated ebook collection is preferably designated by a single, collective metadata. Segments of each of the plurality of ebooks may be rendered for viewing and perusal by a user by means either of a user command, or as an execution of a narrative thread.

### BRIEF DESCRIPTION OF THE FIGURES

These, and further features of the invention, may be better understood with reference to the accompanying specification and drawings depicting the preferred embodiment, in which:

FIG. 1 is a process chart of a first invented method of generating an outline of a multi-tagged ebook;

FIG. 2 is a process chart of a first invented method of preparing a multi-tagged ebook for publication;

FIG. 3 is a is a process chart of a first preferred embodiment of a user experience in reading the invented ebook of FIG. 2;

FIG. 4 is a representation of a digitized text of FIG. 1 divided into segments;

FIG. 5 is a schematic diagram of an exemplary first segment record in which a first segment of FIG. 3 of the invented ebook is comprised;

FIG. 6 is a schematic of node diagram that is organized in accordance with the invented ebook of FIGS. 1, 2 and 3 and a plurality of segment records of FIG. 4;

FIG. 7 is a schematic diagram of an exemplary first segment record by which a first node FIG. 5 of the invented ebook is defined;

FIG. 8A is a block diagram of a first alternate embodiment of a segment record of FIG. 4 and FIG. 5;

FIG. 8B is a block diagram of a second alternate embodiment of a segment record of FIG. 4 and FIG. 5;

FIG. 8C is a block diagram of a third alternate embodiment of a segment record of FIG. 4 and FIG. 5;

FIG. 8D is a block diagram of a fourth alternate embodiment of a segment record of FIG. 4 and FIG. 5;

FIG. 8E is a block diagram of a fifth alternate embodiment of a segment record of FIG. 4 and FIG. 5;

FIG. 8F is a block diagram of a sixth alternate embodiment of a segment record of FIG. 4 and FIG. 5;

FIG. 8G is a block diagram of a seventh alternate embodiment of a segment record of FIG. 4 and FIG. 5;

FIG. 8H is a block diagram of an eighth alternate embodiment of a segment record of FIG. 4 and FIG. 5;

FIG. 8I is a block diagram of a ninth alternate embodiment of a segment record of FIG. 4 and FIG. 5;

FIG. 8J is a block diagram of a tenth alternate embodiment of a segment record of FIG. 4 and FIG. 5;

FIG. 8K is a block diagram of an eleventh alternate embodiment of a segment record of FIG. 4 and FIG. 5;

FIG. 8L is a block diagram of a twelfth alternate embodiment of a segment record of FIG. 4 and FIG. 5;

FIG. 9 is an exemplary node diagram, wherein each nodes references at least one segment record of FIG. 8;

FIG. 10 is a flow chart of an ebook reader in providing a user-interactive process that enables a human reader to access the invented ebook of FIG. 2;

FIG. 11 is a flowchart an invented method of applying a default tag for execution by the ebook reader in interaction with the reader;

FIG. 12 is a flowchart of an invented method of applying a user selected tag as executable by the ebook reader in interaction with the reader;

FIG. 13 is a flowchart of a additional aspects of the invented method of applying a user selected tag for execution by the ebook reader in interaction with the reader;

FIG. 14 is a flowchart of a fourth aspect of the invented method of applying a user selected tag as executable by the ebook reader in interaction with the reader;

FIG. 15 is an illustration of an ebook reader user interface;

FIG. 16 is an illustration of a second ebook reader interface;

FIG. 17 is a representation of a software table that associates tags of FIG. 5 with labels of FIG. 15 and FIG. 16 in one-to-one relationships;

FIG. 18 is a software flowchart of additional optional aspects of the system software of the ebook reader of FIG. 3 and FIG. 20;

FIG. 19 is a schematic diagram of an ebook editing system of FIG. 1 and publishing system of FIG. 2;

FIG. 20 is a schematic diagram of an ebook reader;

FIG. 21A is a process chart of a preferred embodiment of the invented method wherein metadata is updated in response to creation of and modifications to segment records and/or node records;

FIG. 21B is a process chart of an alternate preferred embodiment of the invented method wherein segment records and/or node records are created and/or updated based upon modifications to the metadata;

FIG. 22A is a process chart of a further preferred embodiment of the invented method wherein a segment record is populated by a human editor, and metadata is revised by a human editor;

FIG. 22B is a process chart of a yet further preferred embodiment of the invented method wherein metadata is edited, and a new segment record is populated by a human editor;

FIG. 22C is a process chart of a yet additional preferred embodiment of the invented method wherein a new segment record is populated by a human editor, and the metadata is revised by the editing system;

FIG. 22D is a process chart of a yet additional preferred embodiment of the invented method wherein metadata is revised by a human editor, and a new segment record is populated by the editing system;

FIG. 22E is a process chart of an additional preferred embodiment of the invented method wherein a new segment record is populated by the editing system and the metadata is updated by a human editor;

FIG. 22F is a process chart of a further preferred embodiment of the invented method wherein metadata is revised by the editing system and a new segment record is populated by the human editor;

FIG. 23A is a process chart of a further preferred embodiment of the invented method wherein a node record is populated by a human editor, and metadata is revised by a human editor;

FIG. 23B is a process chart of a yet further preferred embodiment of the invented method wherein metadata is modified by a human editor, and a new node record is subsequently populated by a human editor;

FIG. 23C is a process chart of a yet additional preferred embodiment of the invented method wherein a new node record is populated by a human editor, and the metadata is revised by the editing system;

FIG. 23D is a process chart of a yet additional preferred embodiment of the invented method wherein metadata is revised by a human editor, and a new node record is populated by the editing system;

FIG. 23E is a process chart of an additional preferred embodiment of the invented method wherein a new node record is populated by the editing system and the metadata is revised by a human editor;

FIG. 23F is a process chart of a further preferred embodiment of the invented method wherein metadata is revised by the editing system and a new node record is populated by the human editor;

FIG. 24A is a process chart of a further preferred embodiment of the invented method wherein a segment record is revised by a human editor, and metadata is revised by a human editor;

FIG. 24B is a process chart of a yet further preferred embodiment of the invented method wherein metadata is modified by a human editor, and a segment record is subsequently revised by a human editor;

FIG. 24C is a process chart of a yet additional preferred embodiment of the invented method wherein a segment record is modified by a human editor, and the metadata is revised by the editing system;

FIG. 24D is a process chart of a yet additional preferred embodiment of the invented method wherein metadata is revised by a human editor, and a segment record is revised by the editing system;

FIG. 24E is a process chart of an additional preferred embodiment of the invented method wherein a segment record is modified by the editing system and the metadata is revised by a human editor;

FIG. 24F is a process chart of a further preferred embodiment of the invented method wherein metadata is revised by the editing system and a segment record is modified by the human editor;

FIG. 25A is a process chart of a further preferred embodiment of the invented method wherein a node record is revised by a human editor, and metadata is revised by a human editor;

FIG. 25B is a process chart of a yet further preferred embodiment of the invented method wherein metadata is modified by a human editor, and a node record is subsequently revised by a human editor;

FIG. 25C is a process chart of a yet additional preferred embodiment of the invented method wherein a node record is modified by a human editor, and the metadata is revised by the editing system;

FIG. 25D is a process chart of a yet additional preferred embodiment of the invented method wherein metadata is revised by a human editor, and a node record is revised by the editing system;

FIG. 25E is a process chart of an additional preferred embodiment of the invented method wherein a node record is modified by the editing system and the metadata is revised by a human editor;

FIG. 25F is a process chart of a further preferred embodiment of the invented method wherein metadata is revised by the editing system and a node record is modified by the human editor;

FIG. 26 is a block diagram of the ebook, including a plurality of segment records, and metadata;

FIG. 27A is a block diagram of exemplary metadata;

FIG. 27B is a block diagram is exemplary revised metadata;

FIGS. 28A-28D are block diagrams of exemplary node records;

FIG. 29 is a flowchart of an additional preferred embodiment of the invented method wherein an ebook is generated after a plurality of segments and metadata tags have been generated from a source text;

FIG. 30 is a flowchart of a yet additional preferred embodiment of the invented method wherein segments from disparate ebooks are associated and placed within a narrative sequence, and the metadata of each ebook is updated to reflect the associations

FIG. 31 is a flowchart of an aspect of the invented method wherein back reference to the first ebook is added to the at least one other ebook;

FIG. 32 is a flowchart of a preferred embodiment of the invented method wherein a plurality of ebooks are generated from a single source text;

FIG. 33 is a flowchart of a yet further preferred embodiment wherein a plurality of ebooks are place within a collection, and a collective metadata is created to reflect the placement of the ebooks;

FIG. 34 is a block diagram of an exemplary collection record;

FIG. 35 is a block diagram of exemplary collective metadata; and

FIG. 36 is a flowchart performed by the editing system of FIG. 1 in interaction with a human editor.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

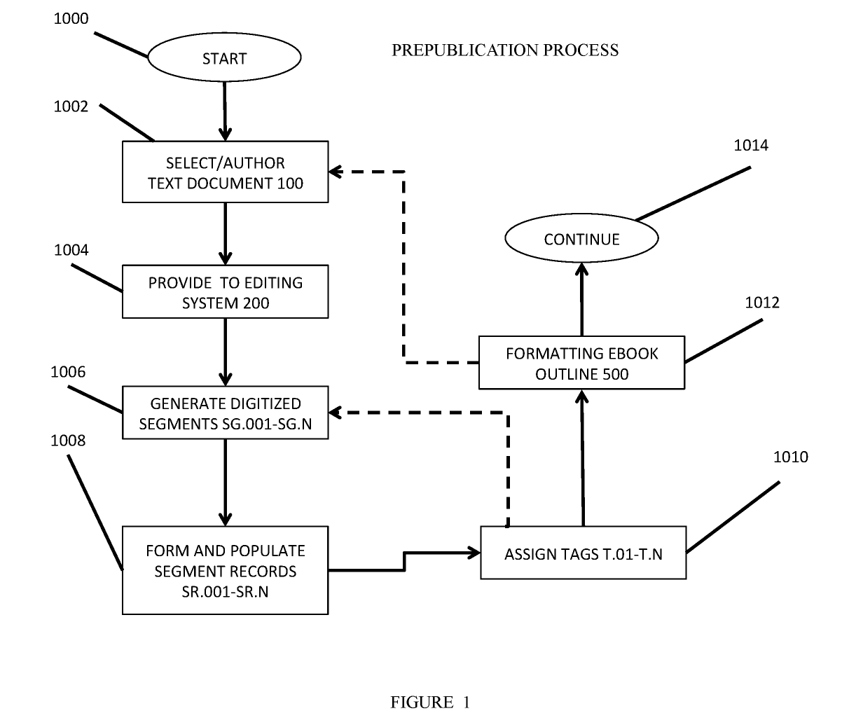

Referring now generally to the Figures and particularly to FIG. 1, FIG. 1 is a process chart of a first invented method of generating a multi-tagged ebook 2 that may be rendered by an invented ebook 4. In step 1002 either an existing text is digitized or digitized text is generated and selected as a digitized source text 100 (hereinafter, “source text” 100). The source text 100 of step 1002 is then input into an editing system 200 by direct keyboard input, or by download from an electronics communications network, e.g., the Internet, or by upload from a computer medium, e.g., a digital memory stick or a digital memory disc. A human editor (hereinafter, “editor”) applies the editing system 200 in step 1006 to generate a plurality of digitized textual segments SG.001-SG.N (hereinafter, “segments” SG.001-SG.N) selected from the source text 100. It is understood that elements of the source text 100 may be duplicated in more than one derivative segment SG.001-SG.N. In response to interaction with the editor, the editing system 200 forms separate segment records SR.01-SR.N in step 1008, wherein each segment record SR.01-SR.N preferably contains at least one segment SG.001-SG.N. The editor assigns one or more tags T.01-T.N & T.DEF to one or more segment records SR.01-SR.N in step 1010. The editor preferably, but optionally, alternatively or additionally, assign a unique sequence number SEQ.001 to SEQ.N to each segment record SR.01-SR.N, whereby each segment record SR.01-SR.N has a unique segment number SEQ.001-SEQ.N that orders the segments according to a one-dimensional sequence wherein no two segment records SR.01-SR.N have the same sequence number SEQ.001-SEQ.N and each sequence number SEQ.001-SEQ.N relates a specific and unique position within the one-dimensional hierarchical structure of the one-dimensional sequence.

The significance and utility of the invented method of the tags T.01-T.N and the segment records SR.01-SR.N will be further explicated in the present disclosure. Examples of aspects of the source text 100 that may be indicated by tags are scene, moment within a time line, character point of view, narrative thread, theme, alternate plot line, alternate time line and/or other suitable literary quality known in the art.

It is understood that the steps of 1006 through 110 may be accomplished as repeated loops, or as iterative loops, as may also be the case of steps 1002 through 1012.

A pre-publication, formatted ebook outline 500 is thereupon generated in step 1012, wherein the ebook outline 500 includes all of the segments SG.001-SG.N and segment records SR.01-SR.N generated in one or more execution of the steps of 1002 through 1012, wherein one or more segment records SR.01-SR.N may be revised or deleted in this prepublication process. It is understood that the steps of 1006 through 110 may be accomplished as repeated loops, or as iterative loops, as may also be the case of steps 1002 through 1012. It is further understood that graphics and additional digitized textual data may be linked with or added to the ebook outline 500 or one or more segment records SR.01-SR.N in one or more executions of step 1008.

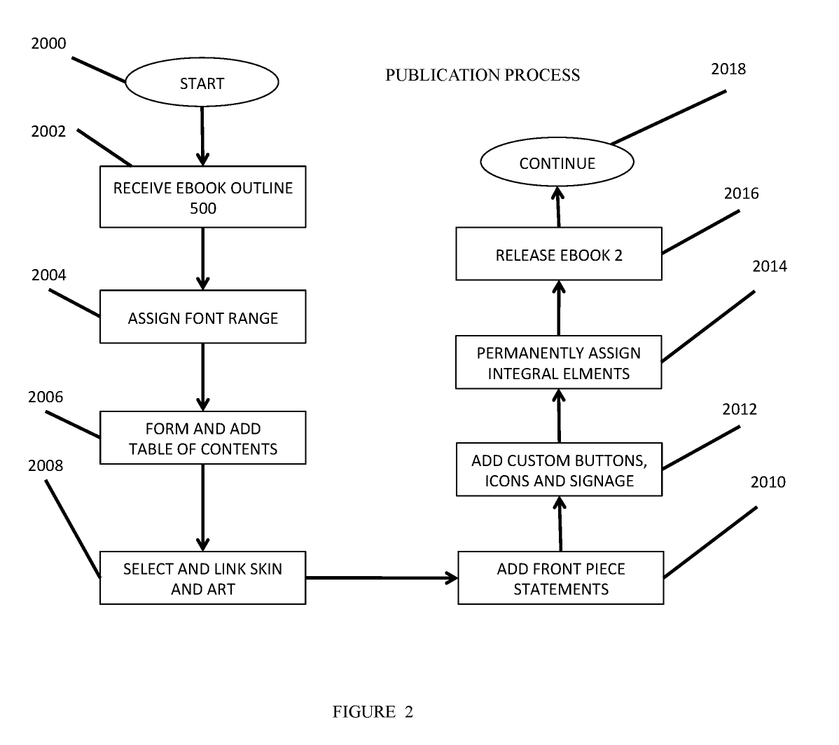

Referring now to FIG. 2, FIG. 2 is a process chart of a publication process. The ebook outline 500 is received by a publishing system 600 in step 2002. A font range is assigned to the ebook outline 500 in step 2004 and a table of contents is formed and added to the ebook outline 500 in step 2006. Preferably, a human publisher (hereinafter, “publisher”) selects and links skin art to the ebook outline 500 in step 2008 and frontispiece statements, e.g., copyright, publisher identification and address, ISBN and publication data, is added to the ebook outline 500 in step 2010. Customized and/or standardized buttons, icons and signage are added to the ebook outline 500 in step 2012. The publisher than permanently selects, signifies and assigns integral elements of the ebook outline 500 in step 2014. The invented ebook 2 is then released in step 2016 for commercial or public distribution in step 2016 through electronic media and/or electronic communications networks, e.g., the Internet.

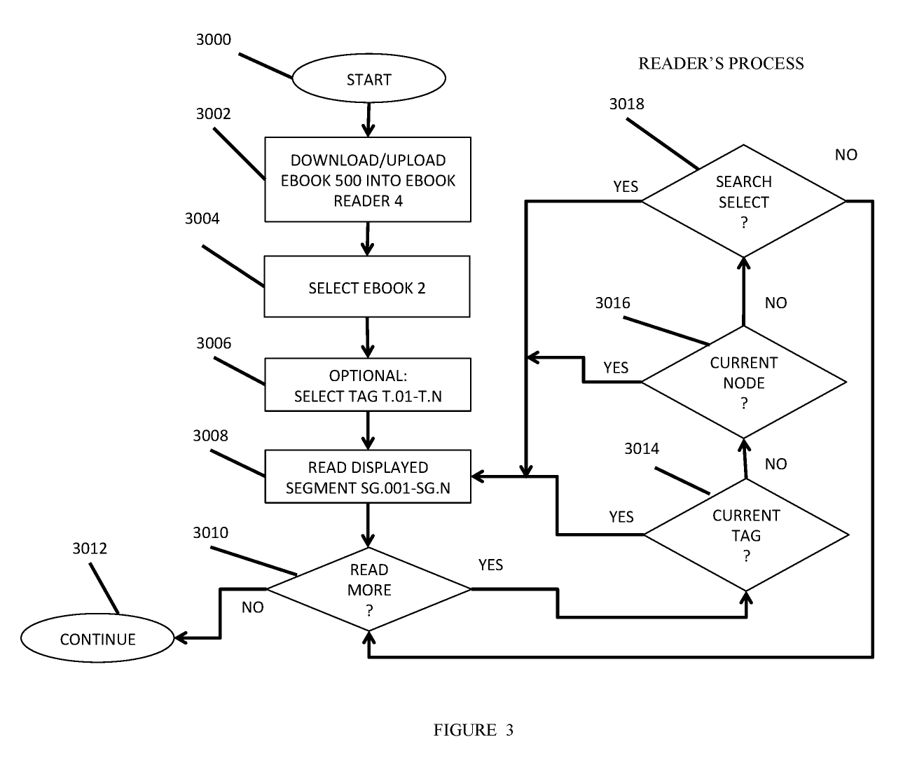

Referring now to FIG. 3, FIG. 3 is a process chart of a human reader's access of the invented ebook 2 by means of an ebook reader 4 having a touch display screen 5. It is understood that the ebook reader 4 may be a general purpose computer, e.g., a tablet, laptop or desktop computer, that is configured with an invented ebook reader software SW.1, or a special purpose ebook reader, such as a KINDLE™ or Nook™ ebook reader. The human reader (hereinafter, “reader”) downloads or uploads the ebook 2 into a digital memory 4A of the ebook reader 4 in step 3002 and directs the ebook reader in step 3004 to initiate visual and/or auditory rendering of the invented ebook.

It is further understood that the nodes ND.001-N.D of the ebook 2 might be recorded as node records NR.01-NR.N and stored in the ebook reader 4 and/or alternatively or optionally generated at run time by the ebook reader 4 and after receipt by the ebook reader 4 of a user selection command of the ebook 2 of step 3004.

In optional step 3006, the reader directs the ebook reader 4 to follow a tag T.01-T.N as selected by the reader in order to provide a user directed nodal pathway through the invented ebook 2. In the alternative, the ebook reader 4 will follow a default nodal pathway through the invented ebook 4 when the reader makes no tag T.01-T.N selections by selecting segments records SR.01-SR.N that each include a default tag T.DEF in an order determined by the sequence numbers SEQ.001-SEQ.N and sequentially rendering the segments SG.001-SG.N of these segment records SR.01-SR.N that include the default tag T.DEF.

In the reading process loop of step 3010 through step 3018, the reader may direct the ebook reader 4 to proceed from step 3010 to step 3012 to exit the reading process loop 3010 through 3018 and proceed on to alternate computational operations. Alternatively, the reader may instruct the ebook reader 4 to proceed to iteratively render successive segment records SR.01-SR.N as accessed in accordance with a tag selection, or default tag selection, of step 3006. In the alternative, the reader in step 3014 may select an alternate tag T.01-T.N. or an alternate segment record SR.01-SR.N associated with a current node ND.001-ND.N may be selected by the reader in step 3016, or an alternate tag T.01-T.N or alternate node ND.001-ND.N may be selected by the reader in a search process of step 3018.

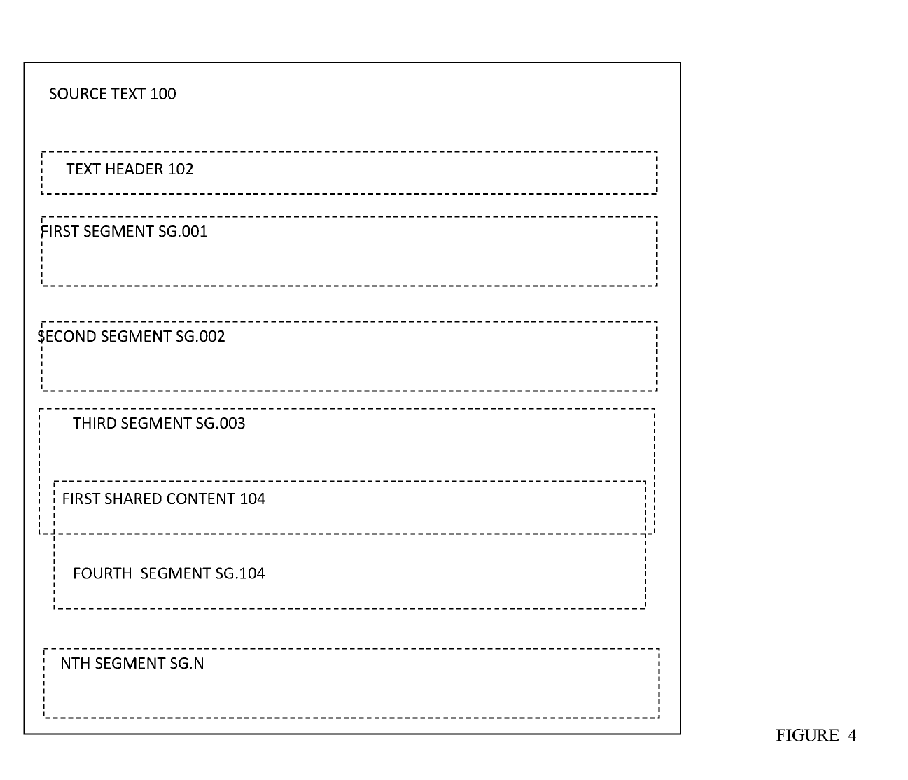

Referring now to FIG. 4, the source text 100 is illustrated as including a header 102 and being divided into segment SG.104 through Nth segment SG.N, wherein N may be as large as the total count of distinguishable words or characters of the source text 100. It is noted that content of the source text 100 may be shared by, or duplicated within, one or more segments SG.104 through SG.N, as illustrated by shared content 114.

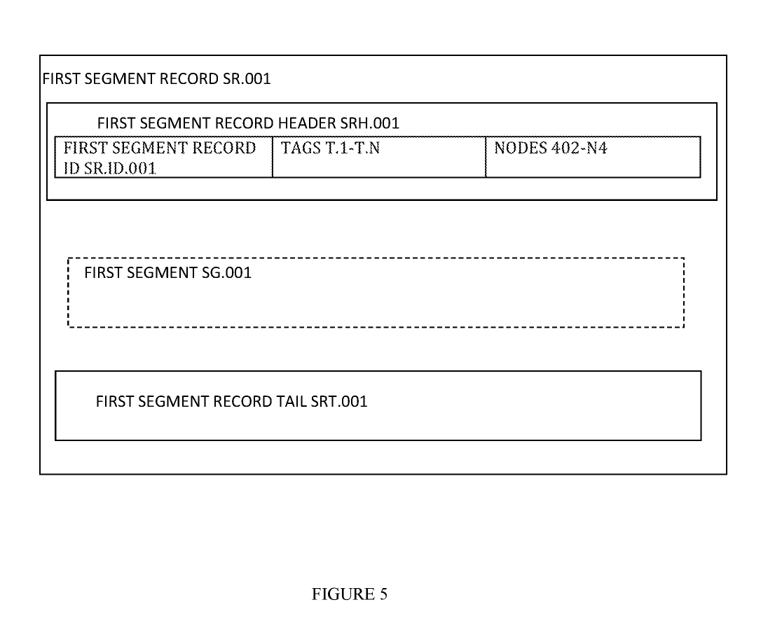

Referring now to FIG. 5, FIG. 5 is an illustration of an exemplary first segment record 302 that includes a first segment record header SRH.001, the first segment SG.104 of the source text 100, and a first segment record tail SRT.001. The first segment record header SRH.001 includes a first segment record identifier SR.ID.001, the default tag T.DEF, and one or more tags T.01-T.N associated by the editor with the first segment SG.104, and a sequence number SEQ.001 assigned by the editor. The exemplary first record 302 may optionally further include references to one or more nodes ND.001-ND.N that are associated with the first segment record 302. The optional first segment record tail SRT.001. contains data useful in managing and transmitting the first segment record SR.001.

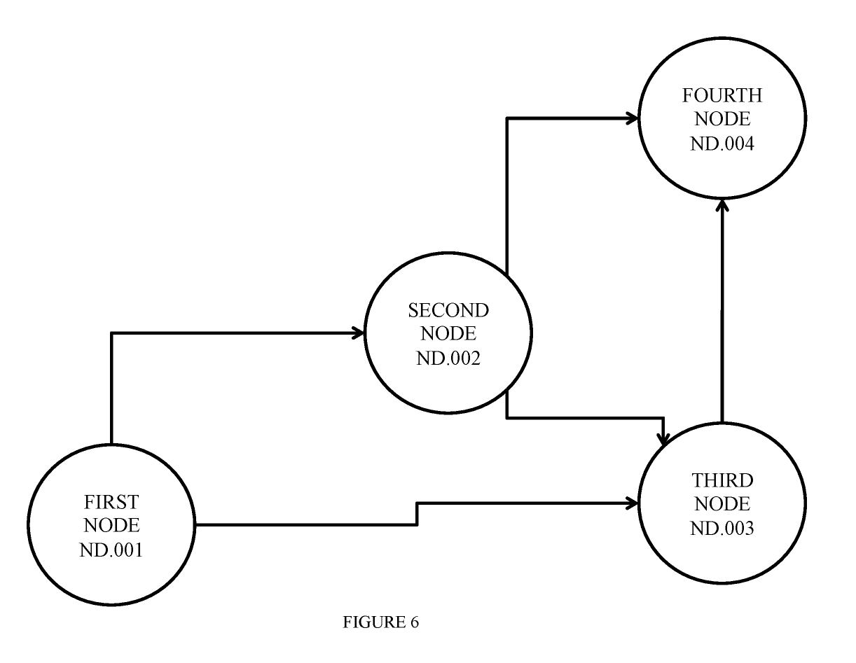

Referring now to FIG. 6, FIG. 6 is an entity diagram of four nodes ND.001-ND.004 of the plurality of nodes ND.001-ND.N. The plurality of nodes ND.001-ND.N are instantiated and generated upon the basis of a query generated by a user in step 3006, or alternatively by a default selection of the ebook reader software SW.1 when the reader does not select a tag T.01-T.N in step 3306 or later.

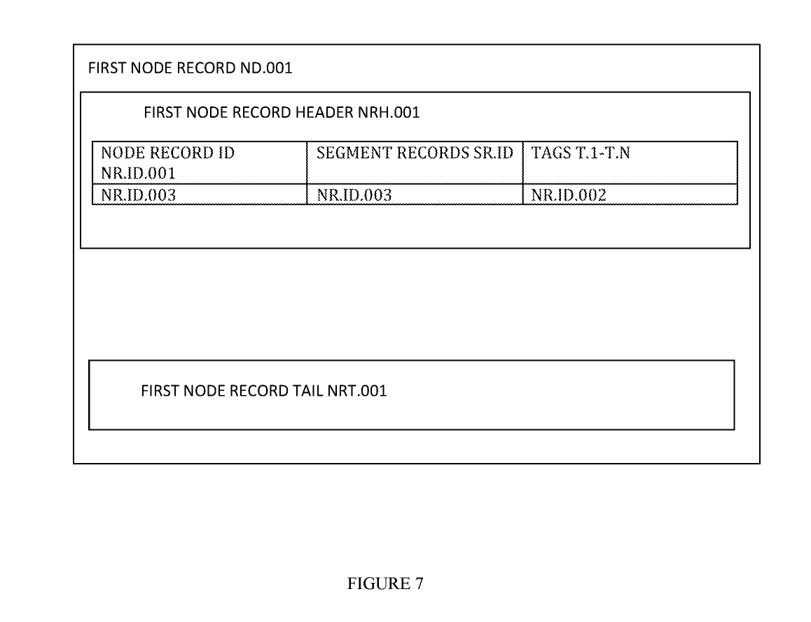

Referring now to FIG. 7, FIG. 7 is an illustration of an exemplary first node record 702 by which the first node ND.001 of FIG. 5 of the invented ebook is defined and that includes a first node record header NRH.001 and a first node record tail NRT.001. The first node record header NRH.001 includes a first node record identifier NR.ID.001, one or more segment record identifiers SR.ID, one or more tags T.01-T.N by the instant reader query of step 3006, and one or more node record identifiers NR.ID. The one or more tags T.01-T.N may alternatively provided as a default set of tags T.01-T.N by the ebook reader software SW.1.

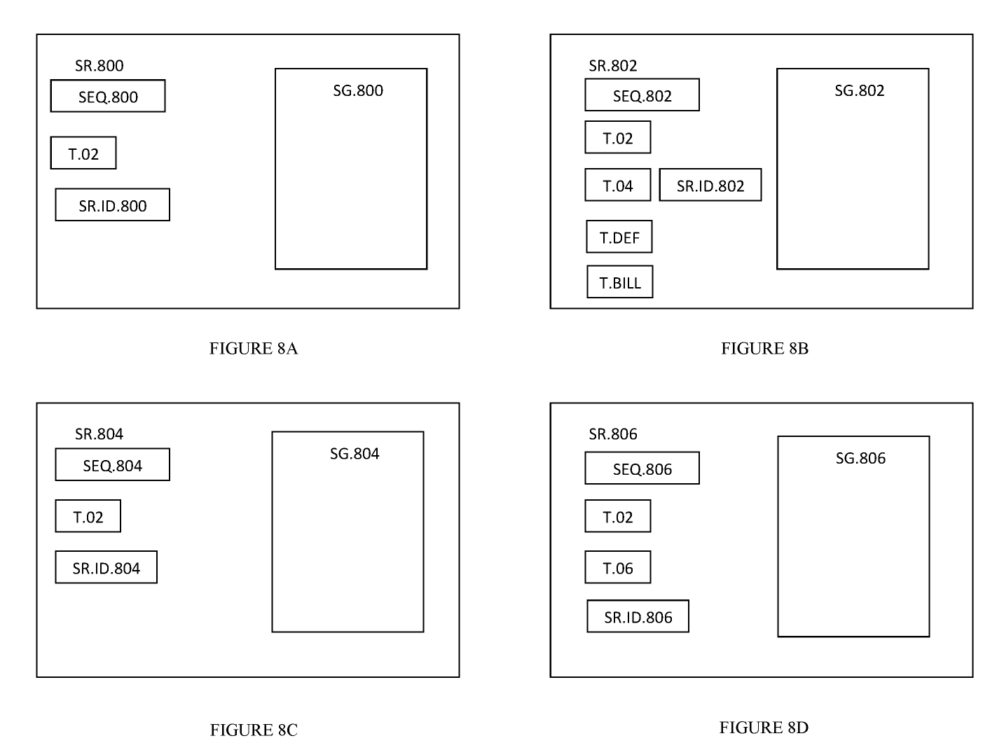

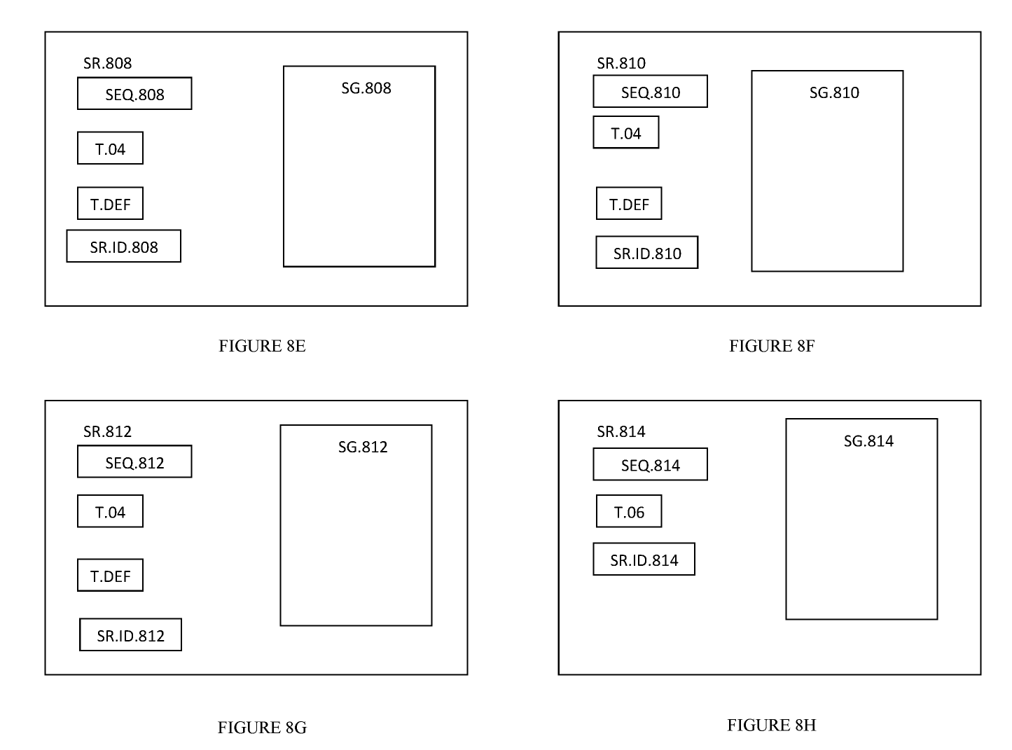

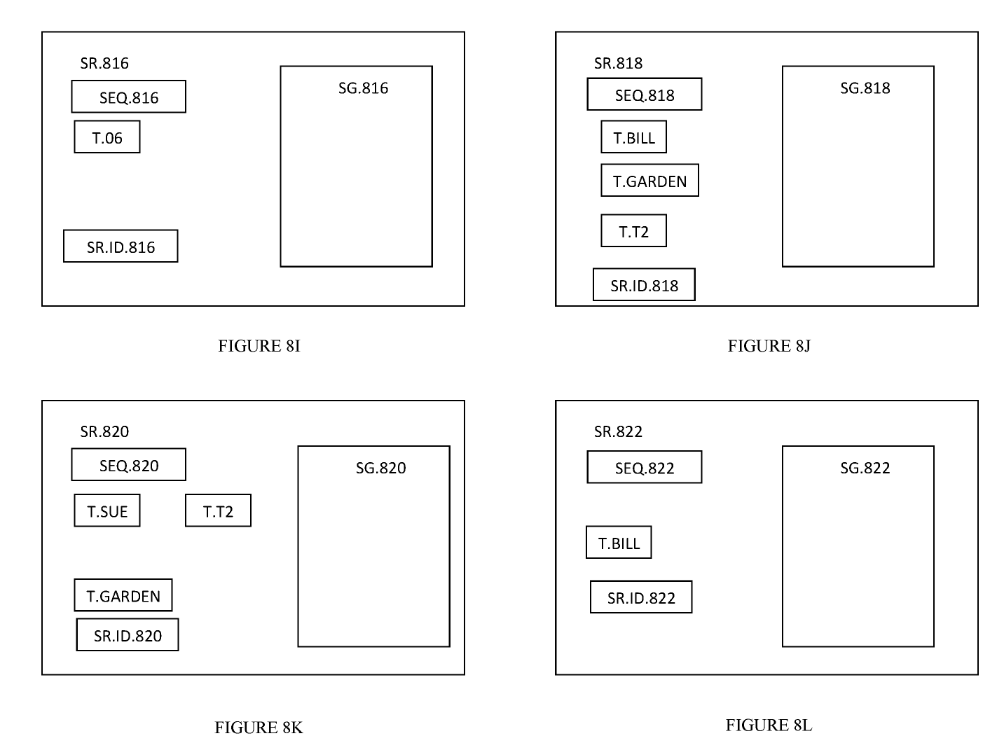

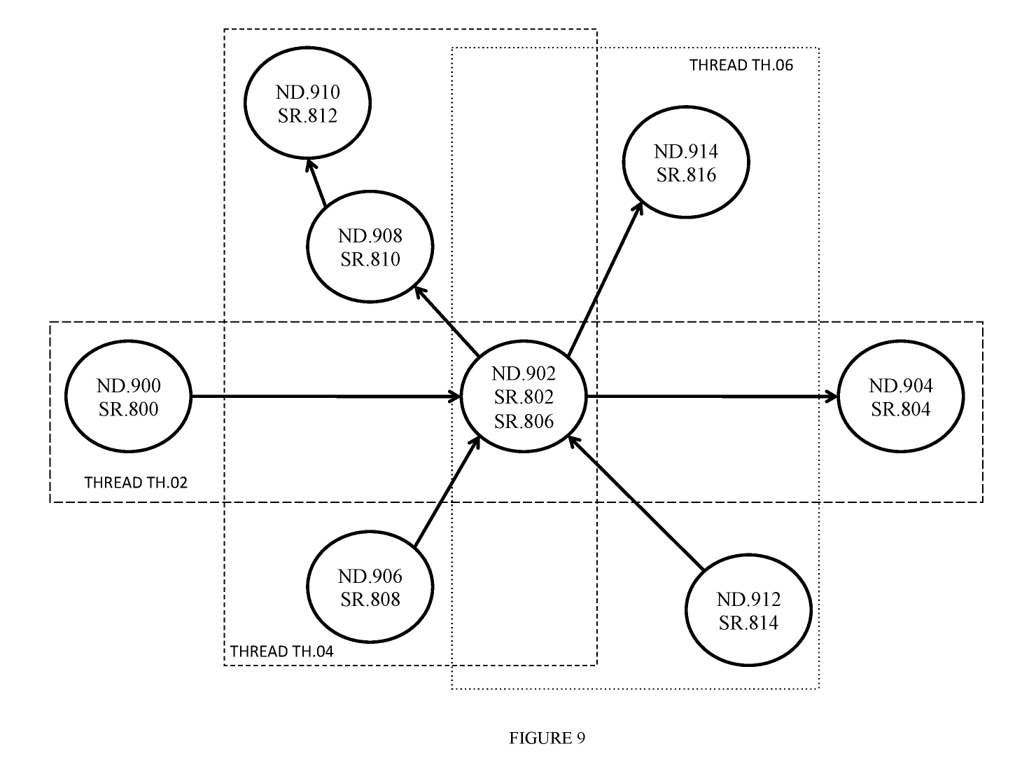

Referring now generally to the Figures and particularly to FIGS. 8A through 8L, FIGS. 8A through 8L each present aspects of individual segment records SEG.800-SEG.822 that each contain unique (a.) sequence numbers SEQ.800-SEQ.822; (b.) segments of the source text SG.800-SG.822; and (c.) combinations of tags, a single sequence number, and a segments. A plurality of three segment records SR.800, SR.802, SR.804 and SR.806 each include a same plot line moment tag T.02 that indicates that each of the four segments SEG.800, SEG.802, SEG.804 and SEG.806 separately comprised within these four segment records SR.800, SR.802, 804 & SR.806 are tagged by the editor as occurring contemporaneously within a plot timeline. Segment records SR.800, SR.802, SR.804 and SR.806 thereby form, or are comprised within, a first plot line moment thread TH.02 as indicated in FIG. 9.

The four segment records SR.802, SR.808, SR.810 & SR.812 each comprise a first character tag T.04 that indicates that the four individual segments SEG.802, SEG.808, SEG.810 & SEG.812 separately comprised within each of these four segment records SR.802, SR.808, SR.810 & SR.812 are each associated with a same first character. These four segment records SR.802, SR.808, SR.810 & SR.812 thereby define, or may be comprised within, a first character thread TH.2 as indicated in FIG. 9.

Similarly, three narrative voice segment records SR.806, SR.814 & SR.816 each comprise a first narrative voice tag T.06 that indicates that each of the three individual segments SEG.806, SEG.814 & SEG.816 separately comprised within these three segment records SR.806, SR.814 & SR.816 are each associated with a same first narrative voice. The three narrative voice segment records SR.806, SR.814 & SR.816 thereby define, or may be comprised within, a first narrative voice thread TH.3 as indicated in FIG. 9.

The segment records SR.800-SR.822 further comprise segment record identifiers SR.ID.800-SR.ID.822, by which the segment records SR.800-SR.822 may be identified within the system and/or by the human editor.

Referring now to FIG. 9, FIG. 9 is a representation of a plurality of nodes ND.900-914 that are generated by the ebook reader 4 prior to, or at runtime, of the ebook 2 and that reference the segment records SR.800-SR.816 of FIG. 8. Nodes ND.900, ND.902 and N904 each reference at least one segment record SR.800, SR.802, SR.804 and SR.806 of the first plot line moment thread TH.02, wherein each of these four segment records SR.800, SR.802, SR.804 and SR.806 separately each include the plot line moment tag T.02. It is noted that the second node ND.902 references the two segment records SR.802 and SR.806.

Four nodes ND.902, ND.906, ND.908 and ND.910 each reference an individual segment record SR.802, SR.808, SR.810 and SR.812 that are comprised within the first character thread TH.04 and indicated by an inclusion of the first character tag T.04 in each of the first character thread segment records SR.802, SR.808, SR.810 & SR.812.

Three nodes ND.902, ND.912, and ND.914 each reference an individual segment record SR.806, SR.806, SR.814 and SR.816 that are comprised within the first narrative voice thread TH.06 and indicated by an inclusion of the first narrative voice tag T.06 in each of the first character thread segment records SR.806, SR.812 & SR.816.

It is understood that in various preferred embodiments of the method of the present invention that one or more nodes ND.001-ND.N may include more than a reference to a segment records SR.01-SR.N, and may comprise some or all of the structure and information of one or more segment records SR.01-SR.N.

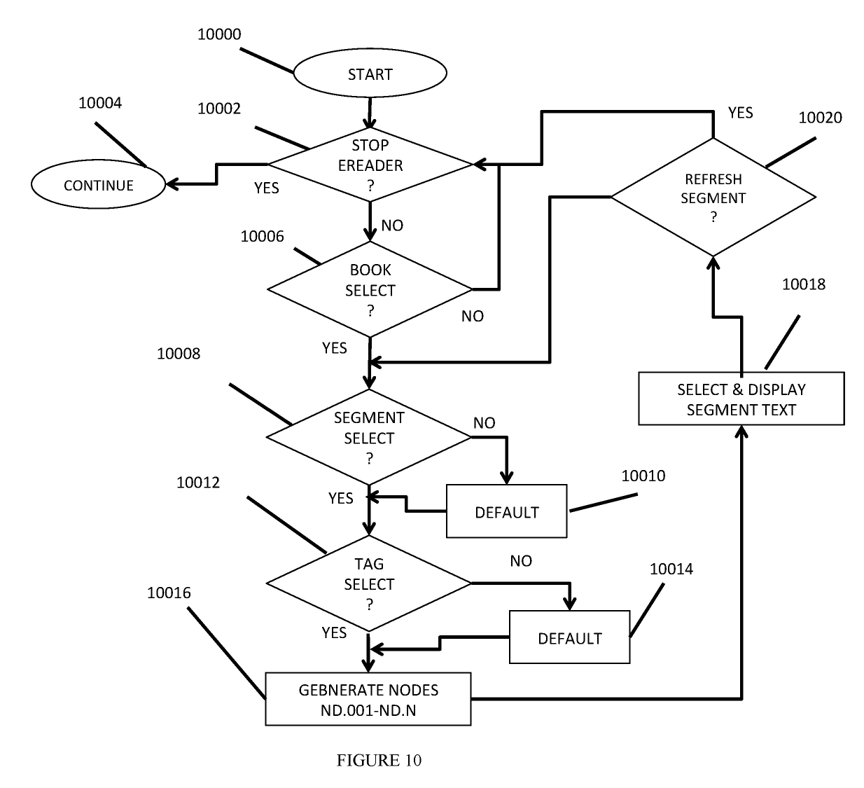

FIG. 10 is a flow chart of the ebook reader 4 in providing a user-interactive process that enables the reader to access the invented ebook 2 in selectable pathways of nodes through the ebook 2. The plurality of nodes ND.001-ND.N are generated by reader interaction in step 3006 of FIG. 3, which may include the reader inputting or selecting an aspect of the ebook 2 that is associated with a tag T.001-T.N, or alternatively, by a default selection by the ebook reader software SW.1 of a default tag T.DEF.

For example, where the editor wishes to associate a particular and unique third character tag T.BILL with a fictional character BILL mentioned in the invented ebook, the third character tag T.BILL will be entered by the editing system 200 as directed by the editor into selected segment records SG.001-SG.N. When the reader requests to sequentially access each segment record SG.001-SG.N that is associated with the third character tag T.BILL, the reader will input into the ebook reader 4, by icon selection or textual input, an interest in the character BILL, and the reader software will thereupon generate and associate a node ND.001-ND.N for each segment record SG.001-SG.N that contains the third character tag T.BILL.

The ebook reader 4 may further optionally associate additional segment records SG.001-SG.N with one or more nodes ND.001-ND.N when an additional record SG.001-SG.N lacks a reference to the third character tag T.BILL but includes a degree of commonality with the immediately associated segment record SG.001-SG.N. For example, when the segment record SR.818 includes both (a.) a second plot line moment tag T.T2 and (b.) a place tag T.GARDEN that relates to a notional garden setting, and the segment record 820 includes both the second plot line tag T.T2 and the place tag T.GAR but also includes a reference to a fourth character tag T. SUE that relates to a fourth character SUE, the second node ND.002 may be generated by the editing software include a reference to the segment record SR.820 based on the commonality of the sharing the place tag T.GARDEN and the second plot line moment tag T.T2 . The ebook reader software SW.1 will thereby be enabled to expeditiously respond to requests by the reader to access segments SG.001-SG.N that are tangentially related to the previously selected third character T.BILL but do not include the third character T.BILL that is optionally the rationale for the a generation of the plurality of nodes ND.001-ND.N.

Referring now generally to the Figures and particularly to FIG. 10, the ebook reader 4 is energized and boots up in step 1000, and in step 10002 determines whether to cease processing the ebook reader software SW.1 and proceed on to alternate computational operations of step 10004. When the ebook reader 4 determines to not proceed on to step 10004 from step 10002, the ebook reader 4 proceeds on to step 10006 and to determine if an ebook 2 selection command has been received from the user. When a selection command is detected by the ebook reader 4 in step 10006, the ebook reader 4 proceeds on from step 10006 to a first execution of step 10008 and to select a default first segment record SR.01 in step 10010 from which to render the default segment SG.104 unless the user inputs a segment select command that indicates selection of an identified alternate segment SG.106-SG.N or segment record SR.01-SR.N. The ebook reader 4 thereupon determines in step 10012 whether to follow a default tag T.DEF of step 10014 or a to follow a tag T.001-T.N provided or selected by the user in a tag selection command. The ebook reader then either generates the plurality of nodes N.001-ND.N that each reference or include at least one segment record SR.01-SR., and proceeds to render a segment SEG.104-SG.N in step 10018 selected from the first node ND.001-ND.N, by reference or inclusion in the instant node ND.001-ND.N. The ebook reader 4 then determines in step 10020 whether to continue sequentially rendering segments SG.001-SG.N by successive executions of the loop of steps 10008 through 10020, or to proceed repeat an execution of step 10002. The ebook reader software SW.1 provides the machine executable instructions required by the ebook reader 4, as directed by user commands, to execute steps 10002 through 10020.

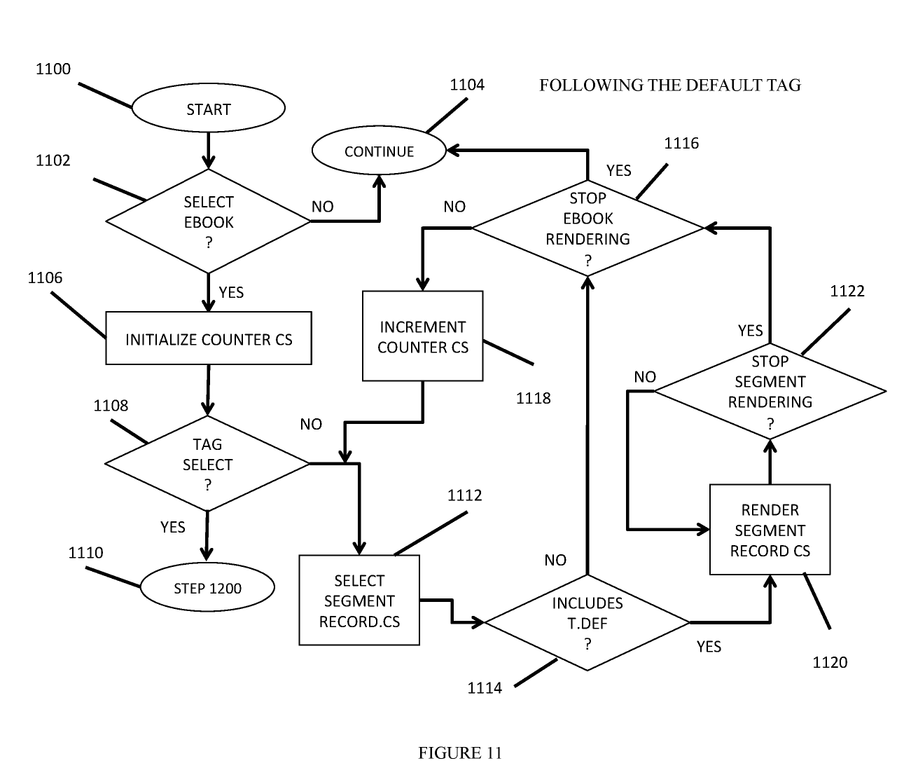

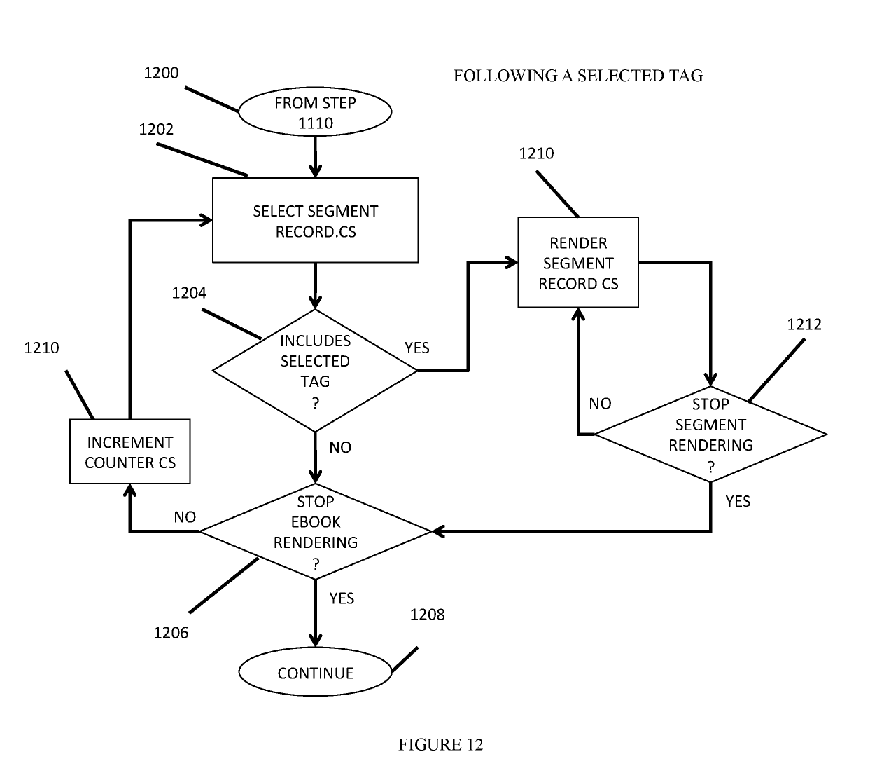

Referring now generally to the Figures and particularly to FIG. 11, FIG. 11 is a flowchart of a second preferred embodiment of aspects of the invented method of applying a default tag T.DEF for execution by the ebook reader 4 in interaction with the reader. The ebook reader 4 determines whether the reader has selected an ebook 2 for rendering in step 1102, and moves on to alternate computational operations of step 1104 when the ebook reader 4 does not detect a user command to select an ebook 2 in step 1102. When the ebook reader 4 in step 1102 detects a user command to select and render an ebook 2, the ebook reader 4 proceeds on to step 1106 and initializes a segment counter CS, and determines in step 1108 whether a tag T.001-T.N has been selected or input by the user. When the ebook reader 4 determines in step 1108 that the user has input or selected a tag T.001-T.N, the ebook reader 4 proceeds form step 1108 to step 1110 and to perform the process of FIG. 12.

Alternatively, when the ebook reader 4 determines in step 1108 that the user has not input or selected a tag T.001-T.N, the ebook reader 4 proceeds from step 1108 to step 1112 and to proceed to sequentially render the segment records SR.01-SR.N that reference the default tag T.DEF. The ebook reader 4 proceeds from step 1112 to execute the logic of steps 1112 through 1122 until the ebook reader 4 determines in an execution of step 1116 that the segment counter CS has been incremented by successive increments to become equal to a maximum count N of segment records SR.01-SR.N, or the user directs the ebook reader 4 to cease rendering the selected ebook 2. More particularly, the ebook reader 4 sequentially examines each segment record SR.01-SR.N to determine if each segment record SR.01-SR.N references or includes the default tag T.DEF, and sequentially renders each segment record SR.01-SR.N that references or includes the default tag T.DEF in step 1120. The user prompts the ebook reader 4 to proceed on to a next segment record in step 1122.

Referring now generally to the Figures and particularly to FIG. 12, FIG. 12 is a flowchart of a third preferred embodiment of aspects of the invented method applying a user selected tag T.001-T.N as executable by the ebook reader 4 in interaction with the reader. In steps 1200 through 1214 the ebook reader 4 sequentially selects each segment record SR.01-SR.N step 1202 and sequentially renders each segment record SR.01-SR.N in step 1210 that references or includes the user selected tag T.001-T.N detected in step 1108. The user prompts the ebook reader 4 to proceed onto a succeeding segment record SR.01-SR.N in step 1214. The ebook reader 4 will continue incrementing the segment counter CS in repeated execution of steps 1202 through 1214 until either (a.) the segment counter becomes equal to or exceeds a maximum segment count N; or (b.) the user enters a command to stop rendering segments SG.001-SG.N in either step 1206 or step 1214.

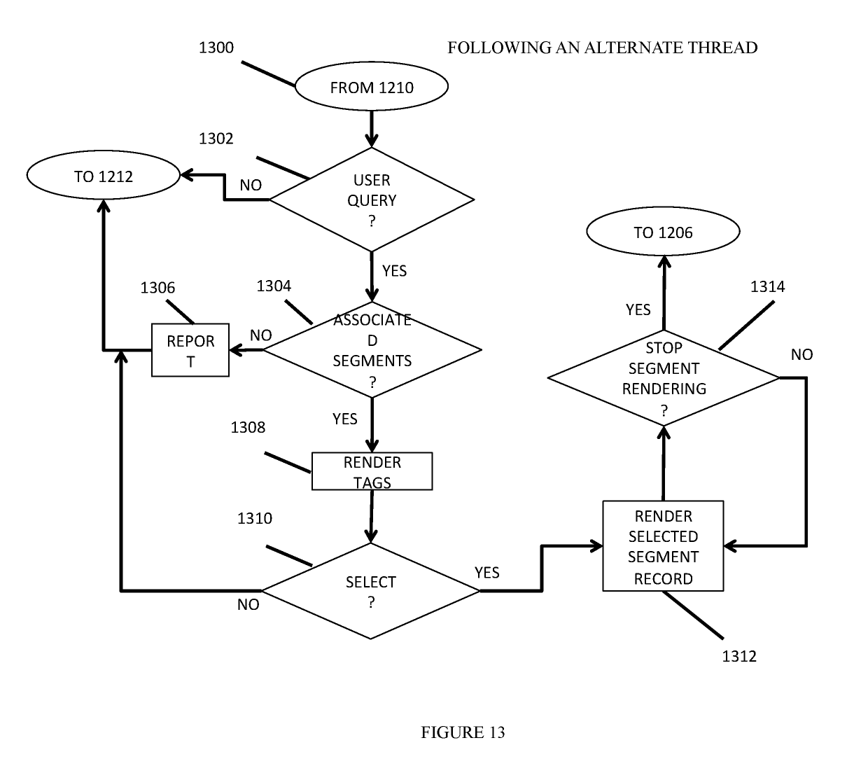

Referring now generally to the Figures and particularly to FIG. 13, FIG. 13 is a flowchart of a third preferred embodiment of aspects of the invented method applying a user selected tag T.001-T.N as executable by the ebook reader 4 in interaction with the reader, whereby the reader directs the ebook reader 4 to select segments SG.001-SG.N associated with an alternate tag T.001-T.N for rendering after the reader previously having selected a first tag T.001-T.N in a previous execution of step 1108. During a rendering in step 1210 of a segment SG.001-SG.N, the user queries whether any other segment records SR.01-SR.N are associated with a same node ND.001-ND.N as the segment record SR.002-SR.N selected in the most recent execution of step 1210. If no additional associated segment records SR.01-SR.N are determined in step 1304, the ebook reader 4 proceeds on to step 1306 and reports to the user a rendered message to that effect. If at least one additional associated segment record SR.01-SR.N is determined in step 1304, the ebook reader 4 proceeds on to step 1308 and render a message indicating the additional tag(s) T.001-T.N in step 1308.

The ebook reader 4 determines in step 1310 whether the reader has selected a different tag T.001-T.N than applied in the most recent execution of step 1210. When the ebook reader 4 determines in step 1310 that the reader has selected a new tag T.001-T.N, the ebook reader 4 renders the segment SG.001-SG.N of the segment record SR.01-SR.N comprising the tag T.001-T.N selected in step 1310. As directed by the reader, the ebook reader 4 ceases rendering the segment SG.001-SG.N of step 1312, and then proceeds from step 1314 to step 1206, and thereafter selects segments SG.001-SG.N for rendering that include the newly selected tag of step 1310 in further implementations of steps 1202 through 1214.

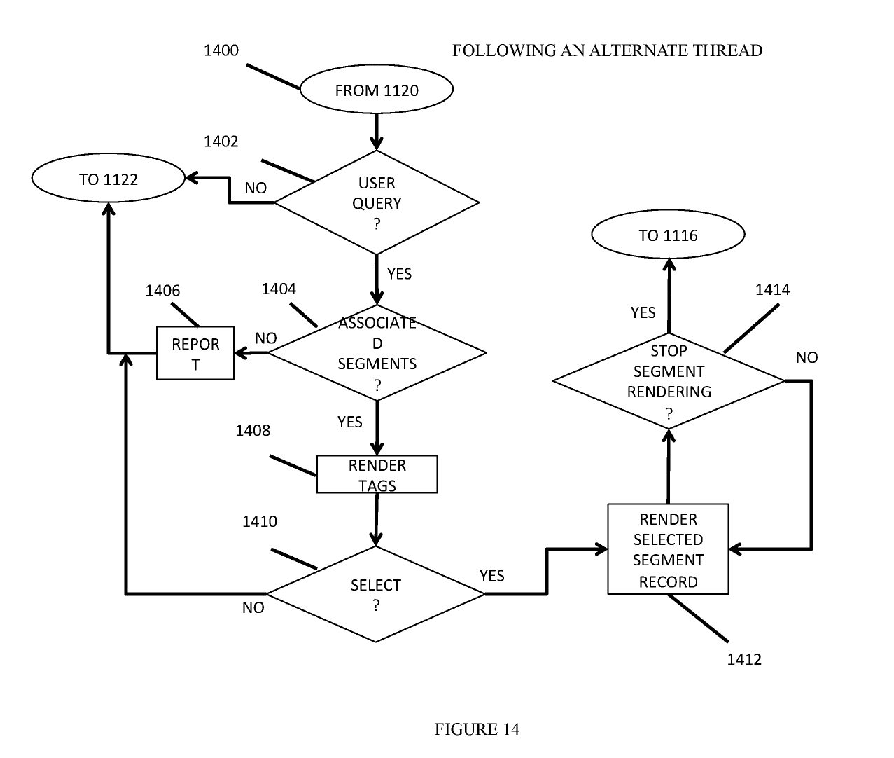

Referring now generally to the Figures and particularly to FIG. 14, FIG. 14 is a flowchart of a fourth preferred embodiment of aspects of the invented method applying a user selected tag T.001-T.N as executable by the ebook reader 4 in interaction with the reader, whereby the reader directs the ebook reader 4 to follow an alternate tag T.001-T.N after initially selecting out segment records SR.01-SR.N that include or reference the default tag T.DEF.

During a rendering in step 1120 of a segment SG.001-SG.N, the user queries whether any other segment records SR.01-SR.N are associated with a same node ND.001-ND.N as the segment record SR.002-SR.N selected in the most recent execution of step 1120. If no additional associated segment records SR.01-SR.N are determined in step 1404, the ebook reader 4 proceeds on to step 1406 and reports to the user a rendered message to that effect. If at least one additional associated segment record SR.01-SR.N is determined in step 1404, the ebook reader 4 proceeds on to step 1408 and render a message indicating the additional tag(s) T.001-T.N in step 1408.

The ebook reader 4 determines in step 1410 whether the reader has selected a different tag T.001-T.N than applied in the most recent execution of step 1120. When the ebook reader 4 determines in step 1410 that the reader has selected a new tag T.001-T.N, the ebook reader 4 renders the segment SG.001-SG.N of the segment record SR.01-SR.N comprising the tag T.001-T.N selected in step 1410. As directed by the reader, the ebook reader 4 ceases rendering the segment SG.001-SG.N of step 1412, and then proceeds from step 1414 to step 1116, and thereafter selects segments SG.001-SG.N for rendering that include the newly selected tag of step 1410 in further implementations of steps 1112 through 1122.

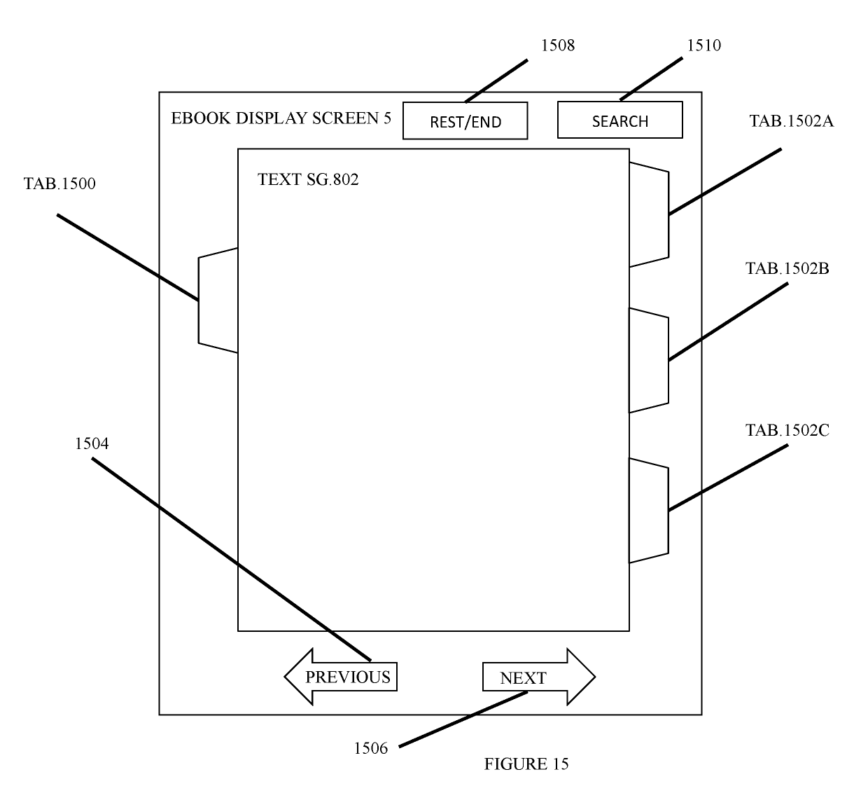

Referring now generally to the Figures and particularly to FIG. 15, FIG. 15 is an illustration of a user interface 1500 of the ebook reader 4 as rendered on the ebook reader display screen 5 under as directed by user interaction and the ebook reader system software SW.1. In this exemplary illustration, a selected text segment SG.802 that is stored within or associated with the exemplary segment record SR.802 is rendered. The current tag T.04, as previously selected by the reader, and that the ebook reader software SW.1 is therefore currently following, is indicated by a first tab label TAB.1500. Additional tags T.02 & T.BILL comprised within or referenced by the exemplary segment record SR.802 are presented respectively by two additional tab labels TAB.1502A and TAB.1502B. In further addition, a fourth tag T.06 of an alternate segment record SR.806 that is associated with a same node ND.902 as is the currently rendered segment SG.802 is indicated by a fourth tab label TAB.1502C.

The user interface 1500 further includes command three command buttons 1504, 1506 & 1508 and a search string input and activation box 1510. The reader may direct the ebook reader 4 to proceed to render a next segment SG.810 in sequentially following the second tag T.04 by activating the NEXT command button 1506. Alternatively, the reader may direct the ebook reader 4 to proceed to render a previous segment SG.808 in following the second tag T.04 in reverse sequence by activating the PREVIOUS command button 1504. Additionally, the reader may direct the ebook reader 4 to cease to render segments SG.001-SG.N by selecting the REST/END command button 1508. Yet alternatively, the ebook reader 4 may enter a textual search string in the string input and activation box 1510 and then activate this box 1510 to direct the ebook reader software SW.1 to find and report instances of the entered string in the ebook 2.

The reader may further direct the ebook reader 4 to render an alternate segment SG.806 by selecting a nodal tab, e.g. fourth tab label TAB.1502C that represents an alternative segment SG.806 that is associated by a node ND.902 with the currently rendered segment SG.802. When an alternate segment record SR.01-SR.N is selected by the reader, the newly selected segment SG.001-SG.N of that selected record SR.01-SR.N is then rendered in the ebook display screen 5 and the current tab label TAB.1500 is revised to reference the newly accessed segment record SR.01-SR.N. For example, should the reader select the third tab label TAB.1502C when rendering the exemplary segment SG.802, the ebook reader SW.1 would react by rendering the alternate text SG.806 of segment record SR.806 and alter the first tab label TAB.1500 to reference both the alternate tag T.06 and the segment record SR.806 that comprises the newly rendered segment SG.806. The additional tab labels TAB.1502A-1502C are also then updated to reference the tab associations of the newly selected segment record SR.806. The command buttons of NEXT 1500A and PREVIOUS 1500B would then track the tag T.06 newly referenced by the first TAB.1500.

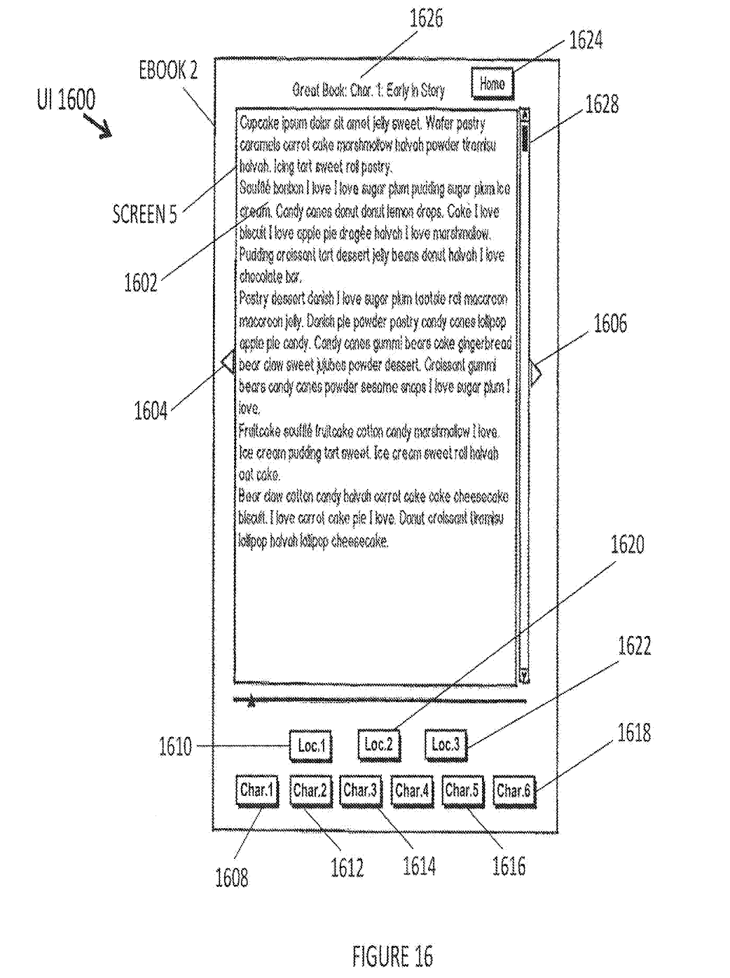

Referring now generally to the Figures and particularly to FIG. 16, FIG. 16 is an illustration of a second user interface 1600 (or “UI” 1600) of the ebook reader 4 as rendered on the ebook reader display screen 5 and generated by the ebook reader system software SW.1 in interaction of the ebook reader 4 with the user. In this exemplary illustration of FIG. 16, a selected text 1602 of an exemplary segment SG.810 that is stored within or associated with the exemplary subsequent segment record SR.810 is rendered in the ebook display screen 5. A previous button 1604 and a next button 1606 are visually rendered in the display screen 5 and enable the user to respectively select the previous segment record SR.802 or the next segment record SR.812 of the first thread TH.04 for deriving a next or following rendering of text 1602 in the display screen 5. Label buttons 1610-1622 enable the user to make choices to select alternate tags T.01-T.N and thereby follow alternate threads TH.1-TH.3 and TH.5-TH.N or to continue to follow a selected thread TH.1-TH.N and render text 1602 and images selected from or associated with segment records SR.01-SR.N. A visually rendered home button 1624 enables the user to direct the ebook reader 4 to return to displaying a home page. An informational text 1626 informs the user about the current ebook 2 being rendered and may provide information concerning the currently rendered text 1602 in relation to the entire ebook 2. A visually rendered scroll control 1628 allows the user to direct the ebook reader 4 to render text 1602 from a single segment record SR.01-SR.N or of a currently selected thread TH.1-TH.N.

The label buttons 1608-1622 may optionally or additionally (a.) be visually shaded or affected to indicate which tag T.01-T.N is being currently followed, e.g., character label CHAR.1 1608 and location label LOC.1 1610; (b.) about other tags T.01-T.N with which the currently rendered text 1602 is associated, e.g. second character label CHAR.2 1612 and third location label LOC.3 1622; and/or additional labels 1614-1620 that are available within the ebook 2 and associated with different tags.

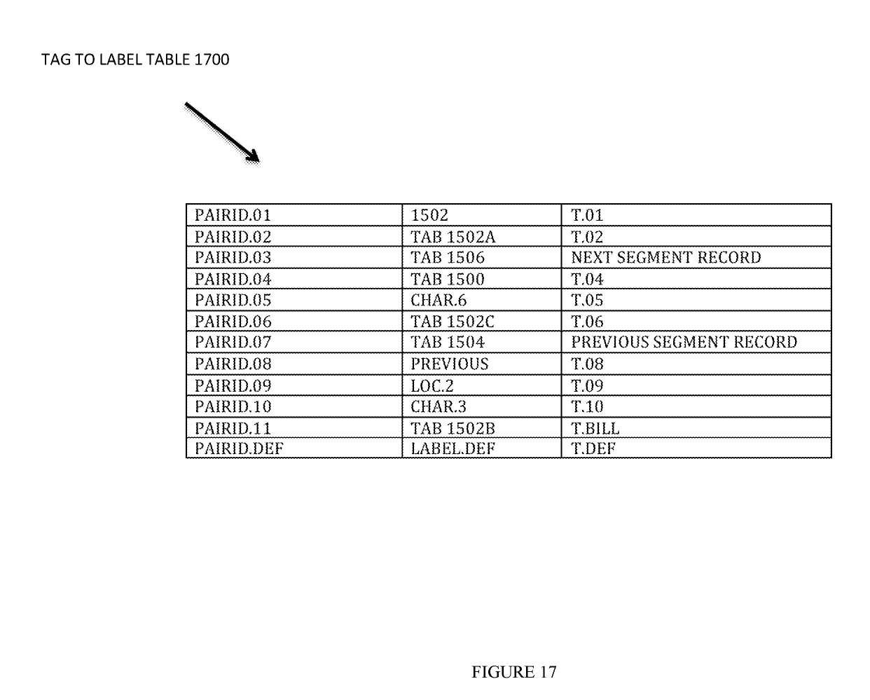

Referring now generally to the Figures and particularly to FIG. 17, FIG. 17 is an illustration of a tag to label table 1700 that separately associates (a.) rendered labels 1610-1622 and tabs 1500, 1504, 1506 1502A-1502C with (b.) tags T.01-T.N. Each label/tab to tag pair has a unique identifier PAIRID.1-PAIR.DEF.

It is understood that certain tags are durably associated with individual labels, for example a second location label LOC.2 is durably related to a ninth tag T.09, a sixth character label CHAR.6 is durably related to a fifth tag T.05, and a default label LABEL.DEF with the default tag T.DEFAULT in accordance with the second UI 1600. It is further understood that the ebook system software SW.1 may alternately or additionally alter the associations of tags T.01-T.N with tabs 1500-1508 in accordance with the user interface 1500.

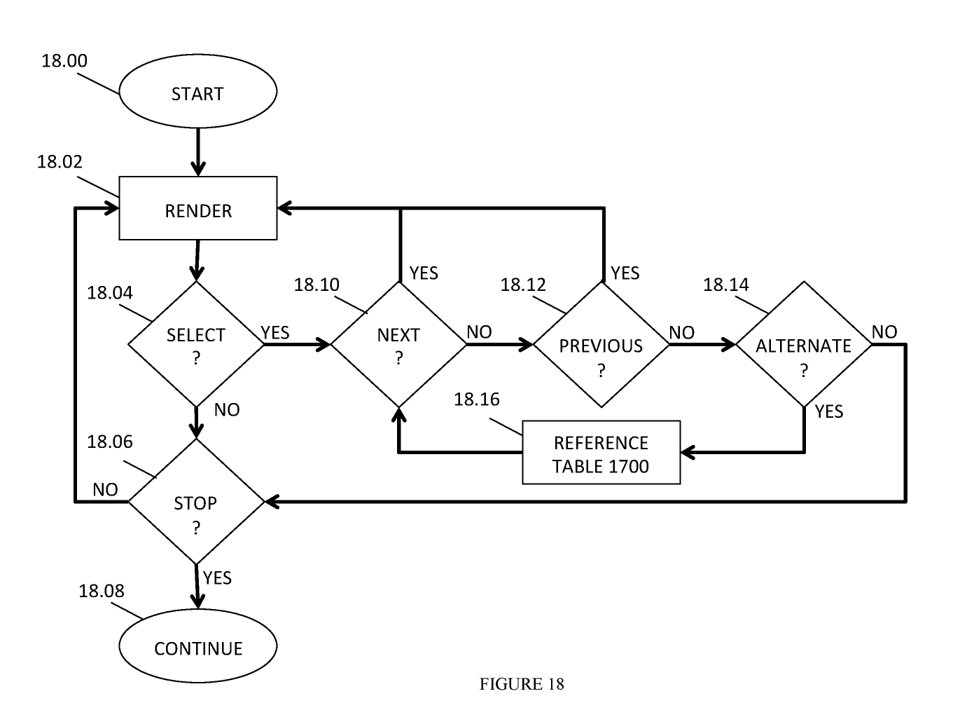

Referring now generally to the Figures and particularly to FIG. 18, FIG. 18 is a software flowchart of additional optional aspects of the system software SW.1 of the ebook reader 4. The ebook reader 4 renders text and images 802 in step 18.02 from the most recently selected segment record SR.01-SR.N, for example the second exemplary segment SG.802 of the second exemplary segment record SR.802. In step 18.04 the ebook reader 4 determines whether a label or tab of the as rendered on the display 5 has been selected by the user. When the ebook reader 4 determines in step 18.04 that no tab or label has been selected by the user, the ebook reader 4 proceeds on step 18.06 and to determine whether to continue rendering content from the most recently selected segment record or to proceed on to step 18.08 and to perform alternate computational processes. The ebook reader 4 more proceed from step 18.06 to step 18.08 on the basis of (a.) a time out condition; (b.) a receipt of a detection of a user selection of the REST/END label 1508; or (c.) a receipt of a power down command down from the user.

When the ebook reader 4 proceeds from step 18.06 to step 18.02, the ebook reader 4 continues to render the content from most recently selected segment record SR.01-SR.N. When the ebook reader 4 determines in step 18.04 a tab or label selection by the user has been detected, the ebook reader 4 proceeds on step 18.10 and to determine whether a next segment record SR.01-SR.N of the same thread TH.01-TH.N of the segment record currently being rendered shall be rendered in a following execution of step 18.02. Alternatively, the ebook reader 4 determines in step 18.12 to determine whether a previous segment record SR.01-SR.N of the same thread TH.01-TH.N of the segment record currently being rendered shall be rendered in a following execution of step 18.02. Still alternatively, the ebook reader 4 determines in step 18.14 if the user has indicated that an segment record SR.01-N of an alternate tag T.01-T.N shall be selected for rendering. When the ebook reader 4 determines in step 18.14 that a segment record SR.01-SR.N of a tag T.01-T.N or thread TH.01-TH.N different from the selected tag T.01-T.MN or Thread TH.01 TH.N of the most recently rendered record, the ebook reader 4 references the table 1700 to relate the selected tab 1500, 1502A-1502C or label 1610-1622 to a tag T.01-T.N.

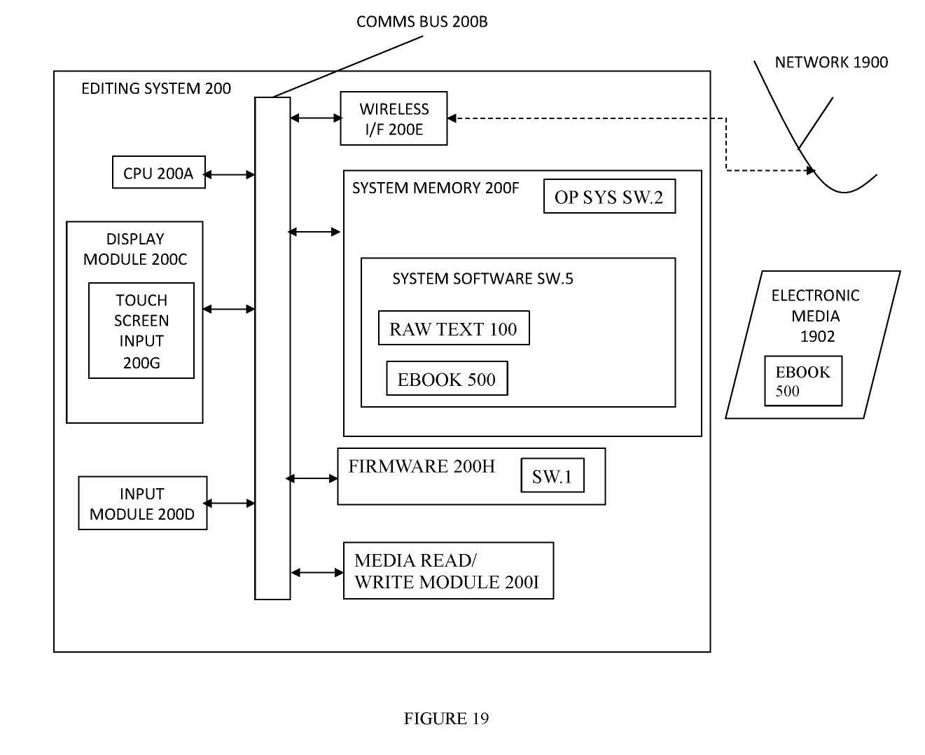

FIG. 19 is a schematic diagram of the ebook editing system 200 and/or ebook publishing system 600. The ebook editing system 200 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art.

The editing system 200A central processing unit is bi-directionally communicatively coupled by a communications bus 200B to a display module 200C, an input module 200D, a wireless communications interface module 200E, a system memory 200F, an optional touch screen input 200G, an optional firmware 200H and/or an optional electronic media read/write module 200I. The electronic media read/write module 200I and an electronic media 1902 are selected to enable reading and writing of the ebook 2 to and from the editing system 200. The editing system software SW.5 enables the editing system 200 to the perform the aspects of the invented method as disclosed herein in the Figures and accompanying text. The network 1900 may be or comprise the Internet, a telephony network, and/or other computer electronic communications network.

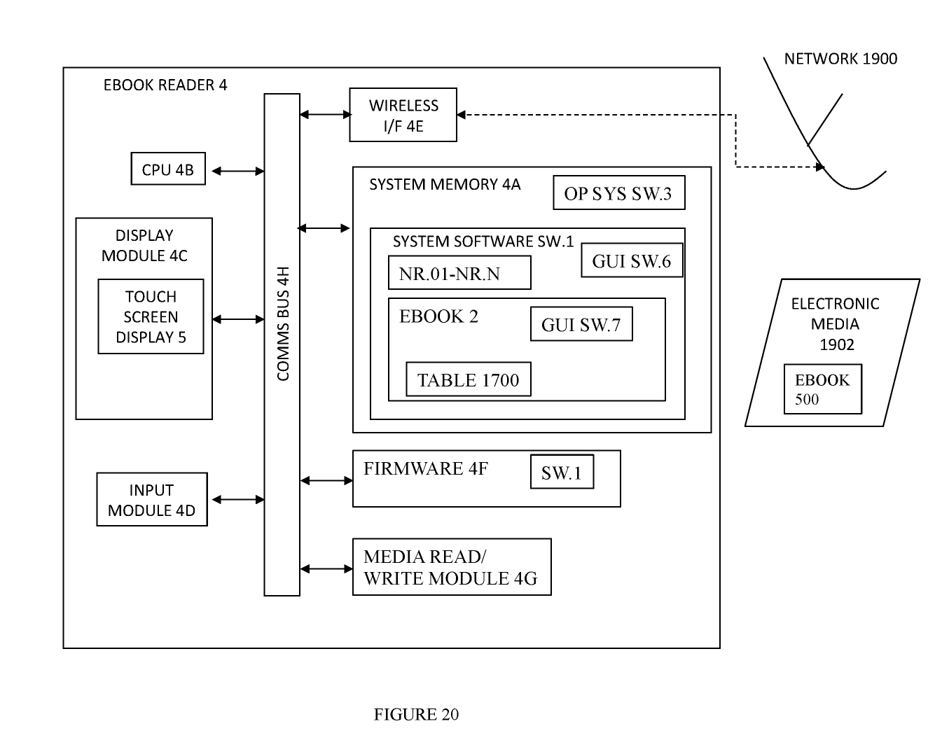

FIG. 20 is a schematic diagram of an ebook reader 4. The ebook reader 4 may be or comprise (a.) a KINDLE ebook reader as marketed by Amazon, Inc. of Seattle, Wash.; (b.) a NOOK ebook reader as marketed by Barnes & Noble, Inc. of New York, N.Y.; (c.) an IPHONE™ cellular telephone as marketed by Apple, Inc. of Cupertino; (d.) an IPAD™ tablet computer adapted for generation of digitized photographic documents and capable of bi-directional communications via the telephony network and the Internet 6 as marketed by Apple, Inc. of Cupertino, Calif.; (e.) an HTC TITAN II™ cellular telephone as marketed by AT&T, Inc. of Dallas, Tex. and running a WINDOWS 7™ operating system as marketed by Microsoft Corporation of Redmond, Wash.; (f.) a GALAXY NEXUS™ smart phone as marketed by Samsung Group of Seoul, Republic of Korea and running an ANDROID™ operating system as marketed by Google, Inc. of Mountain View, Calif.; (g.) a TOUGHPAD™ tablet computer as marketed by Panasonic Corporation of Kadoma, Osaka, Japan and running an ANDROID™ operating system as marketed by Google, Inc. of Mountain View, Calif.; or (h.) other suitable text display system known in the art.

The ebook reader central processing unit 4B is bi-directionally communicatively coupled by a reader communications bus 4B to a display module 4C and the touch screen display 5, a reader input module 4D, a reader wireless communications interface module 4E, the reader system memory 4A, an optional firmware 4F and/or an optional reader electronic media read/write module 4G. The electronic media read/write module 4G and the electronic media 1902 are optionally selected to enable reading and writing of the ebook 2 to and from the ebook reader 4. The ebook reader system software SW.1 enables the ebook reader 4 to perform the aspects of the invented method as disclosed herein in the Figures and accompanying text. A first GUI software SW.6 enables the first user interface and process of FIG. 15 and the user interaction as disclosed in the accompanying text. A second GUI software SW.7 enables the process of the second UI of FIG. 16 and the user interaction as disclosed in the accompanying text.

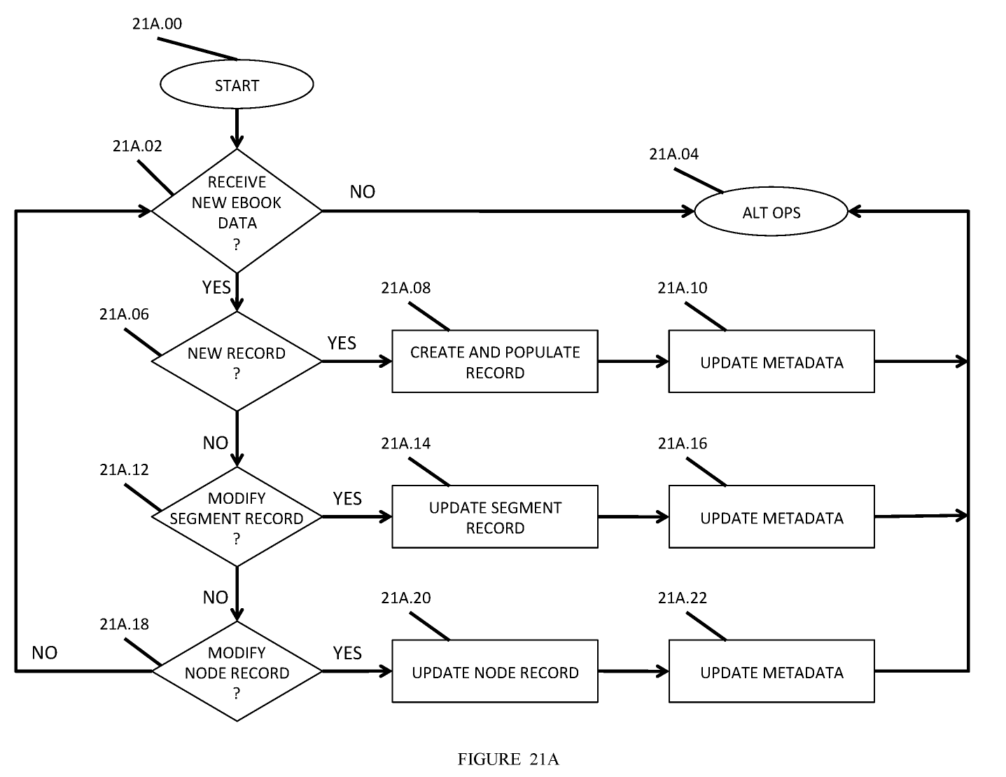

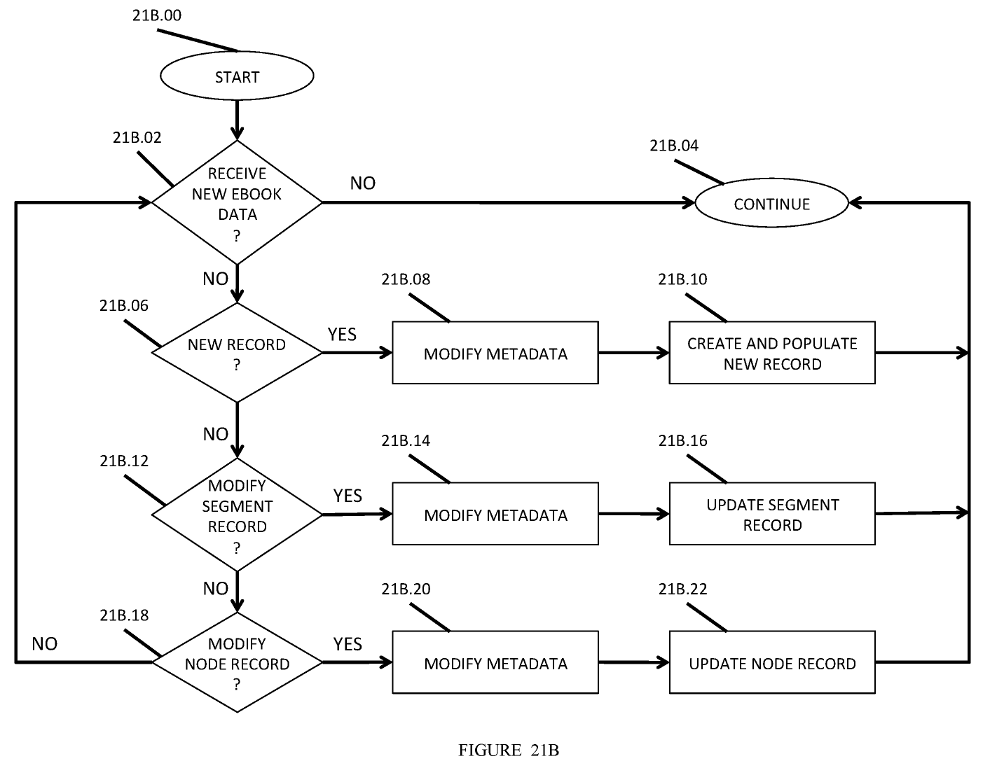

Referring now generally to the Figures, and particularly to FIG. 21A, FIG. 21A is a process chart of a preferred embodiment of the invented method wherein metadata MD.01-MD.N is updated in response to creation of and modifications to segment records SR.01-SR.N and/or node records NR.01-NR.N. The following steps may be executed in their entirety by a human editor, or may alternately be executed by a human editor in combination with the editing system 200 as enabled by the system software SW.5, as described in greater detail in additional drawings described below. In step 21A.02 it is determined whether new digitized textual data has been received. When it is determined that no new digitized textual data has been received, alternate operations are executed in step 21A.04. Alternately, when it is determined in step 21A.02 that new digitized textual data has been received, it is determined in step 21A.06 whether a new record is necessary to categorize the information within the new digitized textual data; the new record may optionally be a new segment record SR.NEW, or may optionally be a new node record NR.NEW. When it is determined that either a new segment record SR.NEW or a new node record NR.NEW is necessary, the new segment record SR.NEW or new node record NR.NEW is created and populated in step 21A.08. In step 21A.10 the metadata is updated to reflect the newly created and populated segment record SR.NEW or node record NR.NEW. Subsequently, alternate operations are executed in step 21A.04.

In the alternative, when it is determined in step 21A.06 that no new record is necessary to categorize the information within the new digitized textual data, in step 21A.12 it is determined whether modification to a segment record SR.01-SR.N is needed to reflect the received new digitized textual data. When it is determined that modification to a segment record SR.01-SR.N is needed to reflect the received new digitized textual data, the segment record SR.01-SR.N is modified in step 21A.14, and the metadata MD.01-MD.N is subsequently updated to reflect the modification to the segment record SR.01-SR.N in step 21A.16. Alternately, when it is determined in step 21A.14 that no modification to a segment record SR.01-SR.N is necessary in response to the received new digitized textual data, in step 21A.18 it is determined whether modifications to a node record NR.01-NR.N are necessary in response to the received new digitized textual data. When it is determined in step 21A.18 that a node record NR.01-NR.N need be modified in response to the received new digitized textual data, the node record is updated in step 21A.20. Subsequently, in step 21A.22, the metadata MD.01-MD.N is updated to reflect the modifications to the node record NR.01-NR.N. Alternate operations are subsequently executed in step 21A.04. When, in the alternative, it is determined in step 21A.18 that no modification need be made to the node record ND.01-ND.N, the steps 21A.02 through 21A.22 are executed as deemed necessary by the human editor or by the editing system 200, enabled by the system software SW.5.

Referring now generally to the Figures, and particularly to FIG. 21B, FIG. 21B is a process chart of an alternate preferred embodiment of the invented method wherein segment records SR.01-SR.N and/or node records NR.01-NR.N are created and/or updated based upon modifications to the metadata MD.01-MD.N. The following steps may be executed in their entirety by a human editor, or may alternately be executed by a human editor in combination with the editing system 200 as enabled by the system software SW.5, as described in greater detail in additional drawings described below. In step 21B.02 it is determined whether new digitized textual data has been received. When it is determined that no new digitized textual data has been received, alternate operations are executed in step 21B.04. Alternately, when it is determined in step 21B.02 that new digitized textual data has been received, it is determined in step 21B.06 whether a new record is necessary to categorize the information within the new digitized textual data; the new record may optionally be a new segment record SR.NEW, or may optionally be a new node record NR.NEW. When it is determined that either a new segment record SR.NEW or a new node record NR.NEW is necessary, metadata MD.01-MD.N is modified or generated to describe the new segment record SR.NEW or new node record NR.NEW in step 21B.08. In step 21B.10 a new segment record SR.NEW or node record NR.NEW is created and populated based upon the modifications to the metadata MD.01-MD.N. Subsequently, alternate operations are executed in step 21B.04.

In the alternative, when it is determined in step 21B.06 that no new record is necessary to categorize the information within the new digitized textual data, in step 21B.12 it is determined whether modification to a segment record SR.01-SR.N is needed to reflect the received new digitized textual data. When it is determined that revisions to a segment record SR.01-SR.N are needed to reflect the received new digitized textual data, the metadata MD.01-MD.N is first modified in step 21B.14, and the segment record SR.01-SR.N is subsequently modified to reflect the modification to the metadata MD.01-MD.N in step 21B.16. Alternately, when it is determined in step 21B.14 that no modification to a segment record SR.01-SR.N is necessary in response to the received new digitized textual data, in step 21B.18 it is determined whether modifications to a node record NR.01-NR.N are necessary in response to the received new digitized textual data. When it is determined in step 21B.18 that a node record NR.01-NR.N need be modified in response to the received new digitized textual data, the metadata MD.01-MD.N is updated in step 21B.20. Subsequently, in step 21B.22, the node record NR.01-NR.N is updated to reflect the modifications to the metadata MD.01-MD.N. Alternate operations are subsequently executed in step 21B.04. When, in the alternative, it is determined in step 21B.18 that no modification need be made to the node record ND.01-ND.N, the steps 21B.02 through 21B.22 are executed as deemed necessary by the human editor or by the editing system 200, enabled by the system software SW.5.

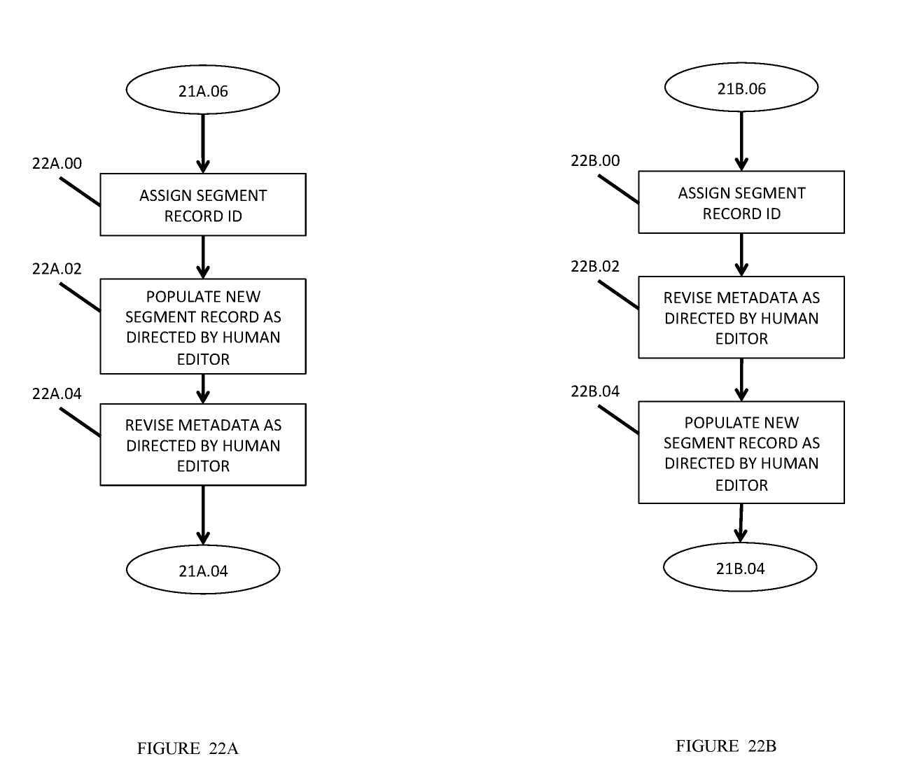

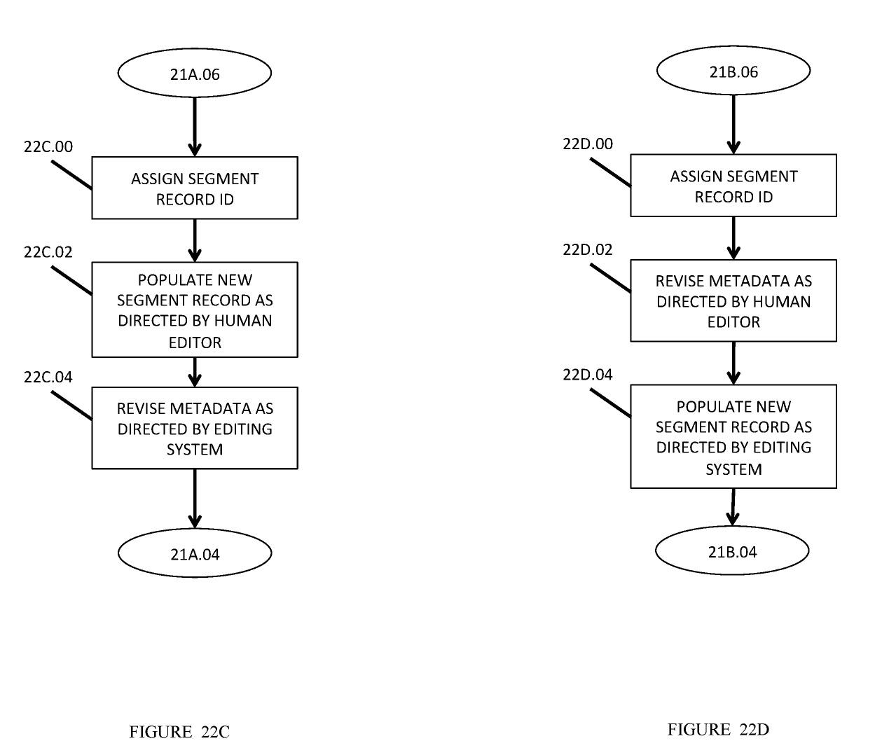

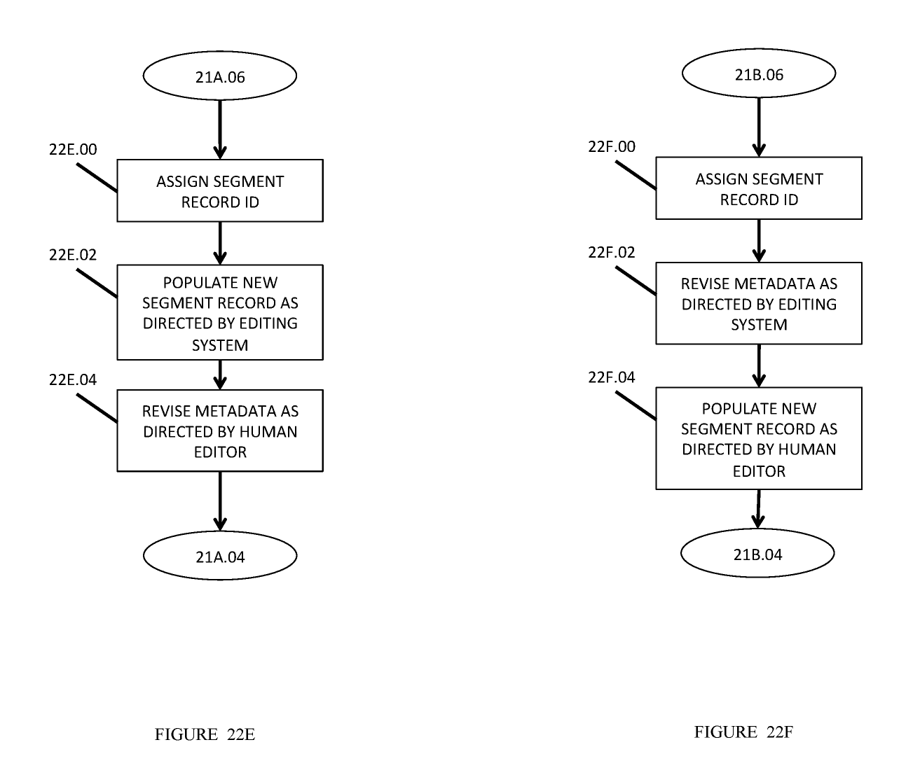

Referring now generally to the Figures, and particularly to FIG. 22A, FIG. 22A is a process chart of a further preferred embodiment of the invented method wherein a segment record SR.01-SR.N is populated by a human editor, and metadata MD.01-MD.N is subsequently revised by a human editor. The human editor proceeds from step 21A.06 of the method of FIG. 21A to step 22A.00 of FIG. 22A. In step 22A.00 the human editor assigns a segment record identifier SR.ID.01-SR.ID.N to the new segment record SR.NEW, by which the new segment record SR.NEW may be identified either to the human editor, or to the editing system 200. In step 22A.02 the human editor populates the new segment record SR.NEW with data derived from a digitized text. The information with which the human editor populates the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the human editor from the source text 100. In step 22A.04 the human editor revises the metadata MD.01-MD.N to reflect the creation and population of the new segment record SR.NEW. The human editor subsequently proceeds to step 21A.04 of the method of FIG. 21A.

Referring now generally to the Figures, and particularly to FIG. 22B, FIG. 22B is a process chart of a yet further preferred embodiment of the invented method wherein metadata MD.01-MD.N is edited, and a new segment record SR.NEW is subsequently populated by a human editor. The human editor proceeds from step 21B.06 of the method of FIG. 21B to step 22B.00. In step 22B.00 the human editor assigns a segment record identifier SR.ID.01-SR.ID.N to the new segment record SR.NEW, by which the new segment record SR.NEW may be identified either to the human editor, or to the editing system 200. In step 22B.02 the human editor revises the metadata MD.01-MD.N. In step 22B.04 the human editor populates the new segment record SR.NEW with data derived from a digitized text. The information with which the human editor populates the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the human editor from the source text 100. The human editor subsequently proceeds to step 21B.04 of the method of FIG. 21B.

Referring now generally to the Figures, and particularly to FIG. 22C, FIG. 22C is a process chart of a yet additional preferred embodiment of the invented method wherein a new segment record SR.NEW is populated by a human editor, and the metadata MD.01-MD.N is revised by the system software SW.5 enabling the editing system 200. The human editor proceeds from step 21A.06 of the method of FIG. 21A to step 22C.00 of FIG. 22C. In step 22C.00 the human editor assigns a segment record identifier SR.ID.01-SR.ID.N to the new segment record SR.NEW, by which the new segment record SR.NEW may be identified either to the human editor, or to the editing system 200. In step 22C.02 the human editor populates the new segment record SR.NEW with data derived from a digitized text. The information with which the human editor populates the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the human editor from the source text 100. In step 22C.04 the system software SW.5 enables the editing system 200 to edit the metadata MD.01-MD.N to reflect the creation and population of the new segment record SR.NEW. The human editor subsequently proceeds to step 21A.04 of the method of FIG. 21A.

Referring now generally to the Figures, and particularly to FIG. 22D, FIG. 22D is a process chart of a yet additional preferred embodiment of the invented method wherein metadata MD.01-MD.N is revised by a human editor, and a new segment record SR.NEW is populated by the system software SW.5. The human editor proceeds from step 21B.06 of the method of FIG. 21D to step 22D.00. In step 22D.00 the human editor assigns a segment record identifier SR.ID.01-SR.ID.N to the new segment record SR.NEW, by which the new segment record SR.NEW may be identified either to the human editor, or to the editing system 200. In step 22D.02 the human editor revises the metadata MD.01-MD.N. In step 22D.04 the system software SW.5 directs the editing system 200 to populate the new segment record SR.NEW with data derived from a digitized text. The information with which the system software SW.5 populates the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the human editor from the source text 100. The human editor subsequently proceeds to step 21B.04 of the method of FIG. 21B.

Referring now generally to the Figures, and particularly to FIG. 22E, FIG. 22E is a process chart of an additional preferred embodiment of the invented method wherein a new segment record SR.NEW is populated by the system software SW.5 enabling the editing system 100 and the metadata MD.01-MD.N is updated by the human editor. The system software SW.5 proceeds from step 21A.06 of the method of FIG. 21A to step 22E.00 of FIG. 22E. In step 22E.00 a segment record identifier SR.ID.01-SR.ID.N is assigned to the new segment record SR.NEW, by which the new segment record SR.NEW may be identified either to the human editor, or to the editing system 200. In step 22E.02 the system software SW.5 enables the editing system 200 to populate the new segment record SR.NEW with data derived from a digitized text. The information with which the system software SW.5 directs the editing system 200 to populate the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the system software SW.5 from the source text 100. In step 22E.04 the human editor revises the metadata MD.01-MD.N to reflect the creation and population of the new segment record SR.NEW. The human editor subsequently proceeds to step 21A.04 of the method of FIG. 21A.

Referring now generally to the Figures, and particularly to FIG. 22F, FIG. 22F is a process chart of a further preferred embodiment of the invented method wherein metadata MD.01-MD.N is revised by the system software SW.5 and a new segment record SR.NEW is populated by the human editor. The human editor proceeds from step 21B.06 of the method of FIG. 21D to step 22F.00. In step 22F.00 the human editor assigns a segment record identifier SR.ID.01-SR.ID.N to the new segment record SR.NEW, by which the new segment record SR.NEW may be identified either to the human editor, or to the editing system 200. In step 22F.02 system software SW.5 directs the editing system 200 revises the metadata MD.01-MD.N. In step 22F.04 the human editor populates the new segment record SR.NEW with data derived from a digitized text. The information with which the human editor populates the new segment record SR.NEW may optionally be, but is not limited to, a plurality of tags T.01-T.N; a sequence number SEQ.001-SEQ.N wherein the new segment record SR.NEW has a unique segment number SEQ.001-SEQ.N that orders the segments according to a one-dimensional sequence; and a text segment SG.01-SG.N derived by the human editor from the source text 100. The human editor subsequently proceeds to step 21B.04 of the method of FIG. 21B.

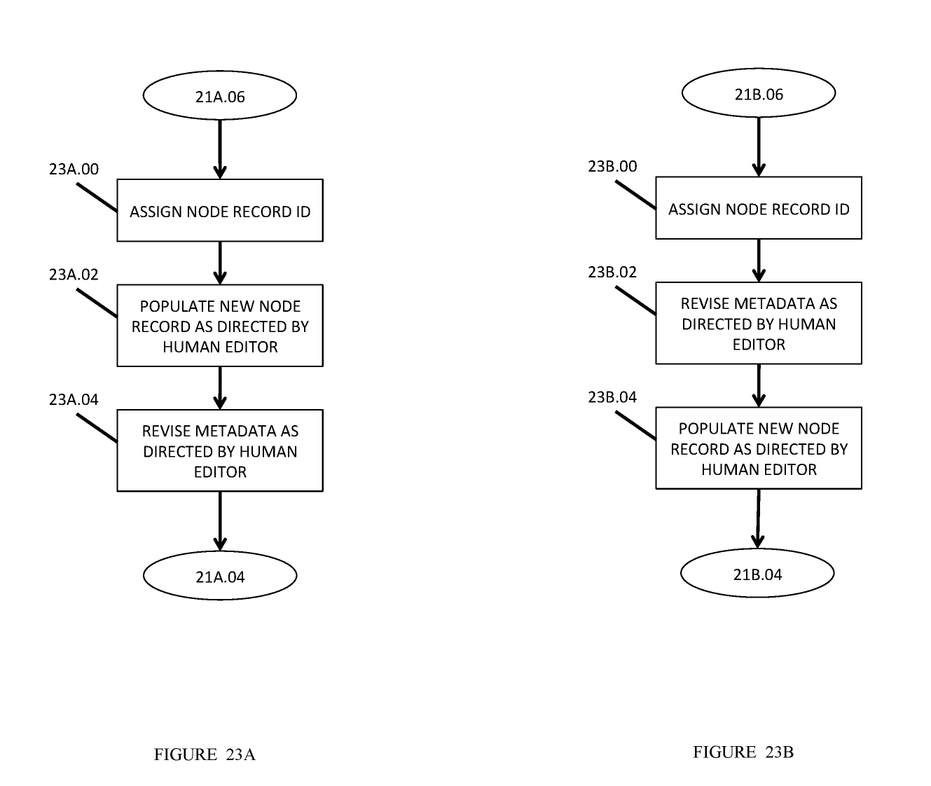

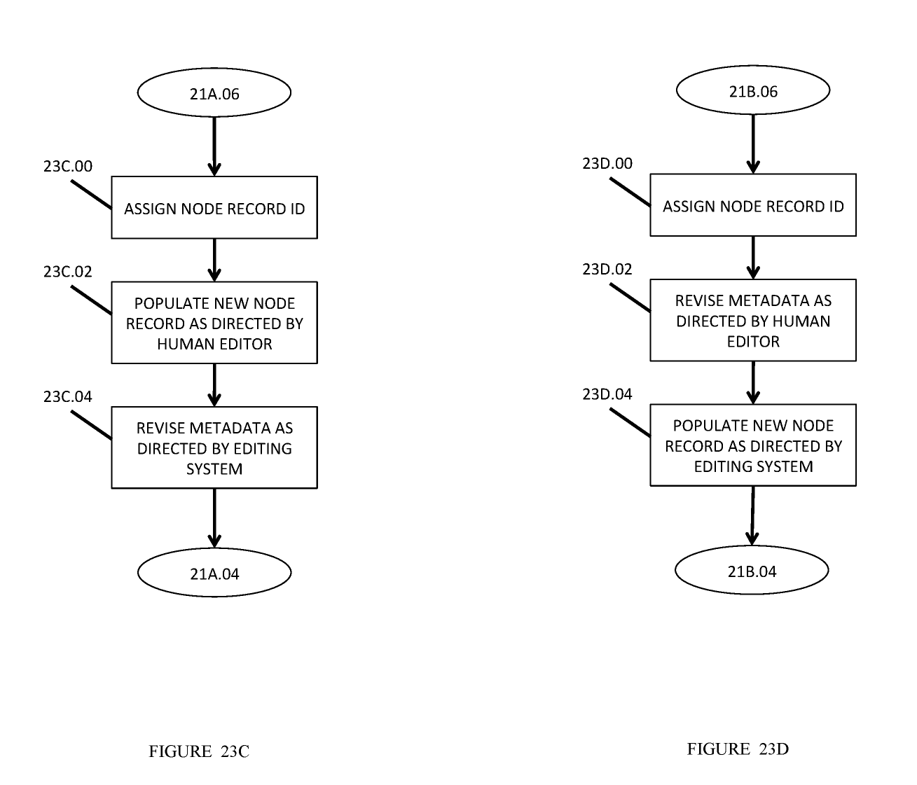

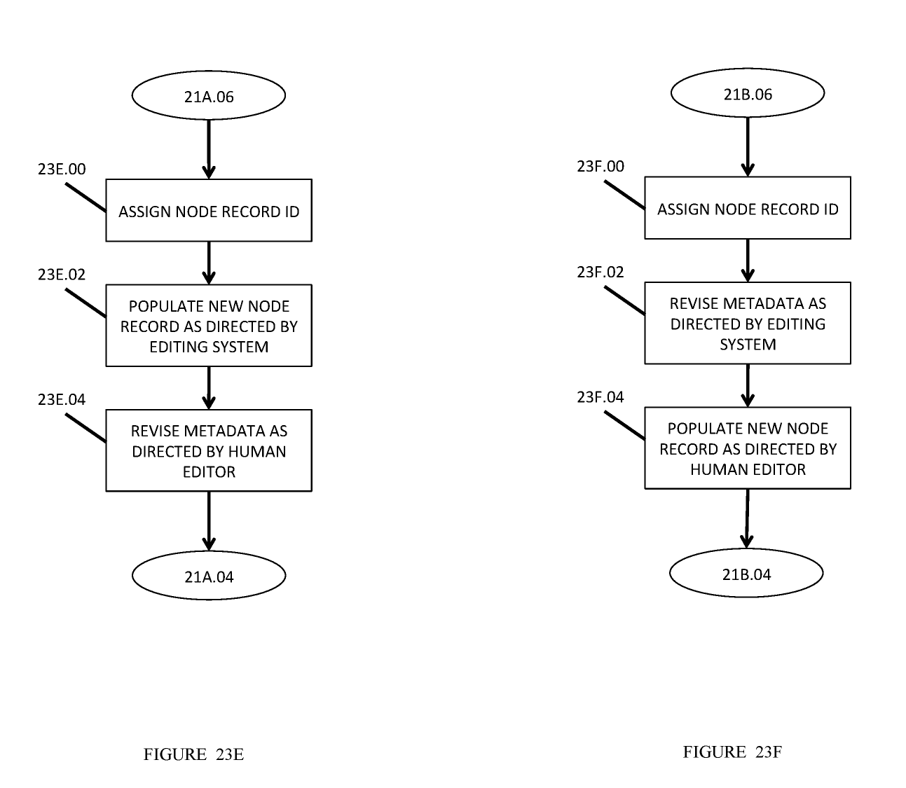

Referring now generally to the Figures, and particularly to FIG. 23A, FIG. 23A is a process chart of a further preferred embodiment of the invented method wherein a new node record NR.NEW is populated by a human editor, and metadata MD.01-MD.N is revised by a human editor. The human editor proceeds from step 21A.06 of the method of FIG. 21A to step 23A.00 of FIG. 23A. In step 23A.00 the human editor assigns a node record identifier NR.ID.01-NR.ID.N to the new node record NR.NEW, by which the new node record NR.NEW may be identified either to the human editor, or to the editing system 200. In step 23A.02 the human editor populates the new node record NR.NEW with data derived from a digitized text. The information with which the human editor populates the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. In step 23A.04 the human editor revises the metadata MD.01-MD.N to reflect the creation and population of the new node record NR.NEW. The human editor subsequently proceeds to step 21A.04 of the method of FIG. 21A.

Referring now generally to the Figures, and particularly to FIG. 23B, FIG. 23B is a process chart of a yet further preferred embodiment of the invented method wherein metadata MD.01-MD.N is modified by a human editor, and a new node record ND.NEW is subsequently populated by a human editor. The human editor proceeds from step 21B.06 of the method of FIG. 21B to step 23B.00 of FIG. 23B. In step 23B.00 the human editor assigns a node record identifier NR.ID.01-NR.ID.N to the new node record NR.NEW, by which the new node record NR.NEW may be identified either to the human editor, or to the editing system 200. In step 23B.02 the human editor revises the metadata MD.01-MD.N. In step 23B.04 the human editor populates the new node record NR.NEW with data derived from a digitized text. The information with which the human editor populates the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. The human editor subsequently proceeds to step 21B.04 of the method of FIG. 21B.

Referring now generally to the Figures, and particularly to FIG. 23C, FIG. 23C is a process chart of a yet additional preferred embodiment of the invented method wherein a new node record ND.NEW is populated by a human editor, and the metadata MD.01-MD.N is revised by the software system SW.5 enabling the editing system 200. The human editor proceeds from step 21A.06 of the method of FIG. 21A to step 23C.00 of FIG. 23C. In step 23C.00 the human editor assigns a node record identifier NR.ID.01-NR.ID.N to the new node record NR.NEW, by which the new node record NR.NEW may be identified either to the human editor, or to the editing system 200. In step 23C.02 the human editor populates the new node record NR.NEW with data derived from a digitized text. The information with which the human editor populates the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. In step 23C.04 the system software SW.5 directs the editing system 200 to revise the metadata MD.01-MD.N to reflect the creation and population of the new node record NR.NEW. The human editor subsequently proceeds to step 21A.04 of the method of FIG. 21A.

Referring now generally to the Figures, and particularly to FIG. 23D, FIG. 23D is a process chart of a yet additional preferred embodiment of the invented method wherein metadata MD.01-MD.N is revised by a human editor, and a new node record ND.NEW is populated by the editing system 200 as enabled by the system software SW.5. The human editor proceeds from step 21B.06 of the method of FIG. 21B to step 23D.00 of FIG. 23D. In step 23D.00 the human editor assigns a node record identifier NR.ID.01-NR.ID.N to the new node record NR.NEW, by which the new node record NR.NEW may be identified either to the human editor, or to the editing system 200. In step 23D.02 the human editor revises the metadata MD.01-MD.N. In step 23D.04 the system software SW.5 directs the editing system 200 to populate the new node record NR.NEW with data derived from a digitized text. The information with which the system software SW.5 directs the editing system 200 to populate the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. The human editor subsequently proceeds to step 21B.04 of the method of FIG. 21B.

Referring now generally to the Figures, and particularly to FIG. 23E, FIG. 23E is a process chart of an additional preferred embodiment of the invented method wherein a new node record NR.NEW is populated by the editing system 200 as enabled by the system software SW.5 and the metadata MD.01-MD.N is revised by a human editor. The human editor proceeds from step 21A.06 of the method of FIG. 21A to step 23E.00 of FIG. 23E. In step 23E.00 the human editor assigns a node record identifier NR.ID.01-NR.ID.N to the new node record NR.NEW, by which the new node record NR.NEW may be identified either to the human editor, or to the editing system 200. In step 23E.02 the system software SW.5 enables the editing system 200 to populate the new node record NR.NEW with data derived from a digitized text. The information with which the system software SW.5 enables the editing system 200 to populate the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. In step 23E.04 the human editor revises the metadata MD.01-MD.N to reflect the creation and population of the new node record NR.NEW. The human editor subsequently proceeds to step 21A.04 of the method of FIG. 21A.

Referring now generally to the Figures, and particularly to FIG. 23F, FIG. 23F is a process chart of a further preferred embodiment of the invented method wherein metadata MD.01-MD.N is revised by the editing system 200 as enabled by the system software SW.5 and a new node record NR.NEW is populated by the human editor. The human editor proceeds from step 21B.06 of the method of FIG. 21B to step 23F.00 of FIG. 23F. In step 23F.00 the human editor assigns a node record identifier NR.ID.01-NR.ID.N to the new node record NR.NEW, by which the new node record NR.NEW may be identified either to the human editor, or to the editing system 200. In step 23F.02 the system software SW.5 enables the editing system 200 to revise the metadata MD.01-MD.N. In step 23F.04 the human editor populates the new node record NR.NEW with data derived from a digitized text. The information with which the human editor populates the new node record NR.NEW may optionally be, but is not limited to, a plurality of tag identifiers T.ID.01-T.ID.N; a plurality of alternate node record identifiers NR.ID.01-NR.01.N, and a plurality of segment record identifiers SR.ID.01-SR.ID.N; and one or more thread identifiers TH.ID.01-TH.ID.N, which narrative threads TH.01-TH.N with which the plurality of nodes ND.01-ND.N are associated. The human editor subsequently proceeds to step 21B.04 of the method of FIG. 21B.

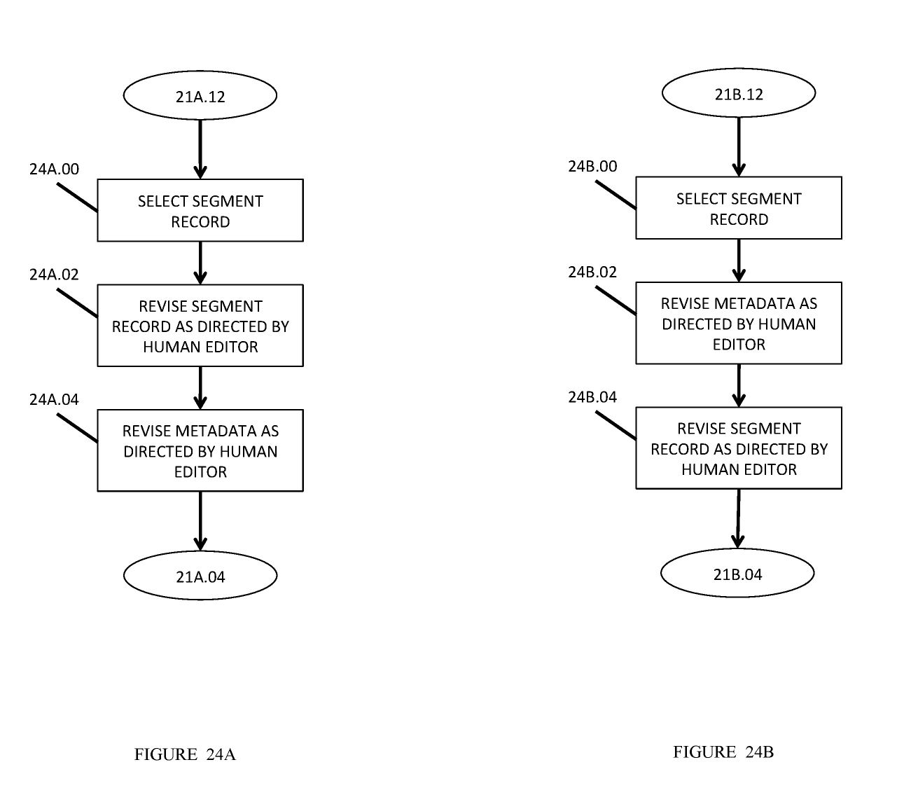

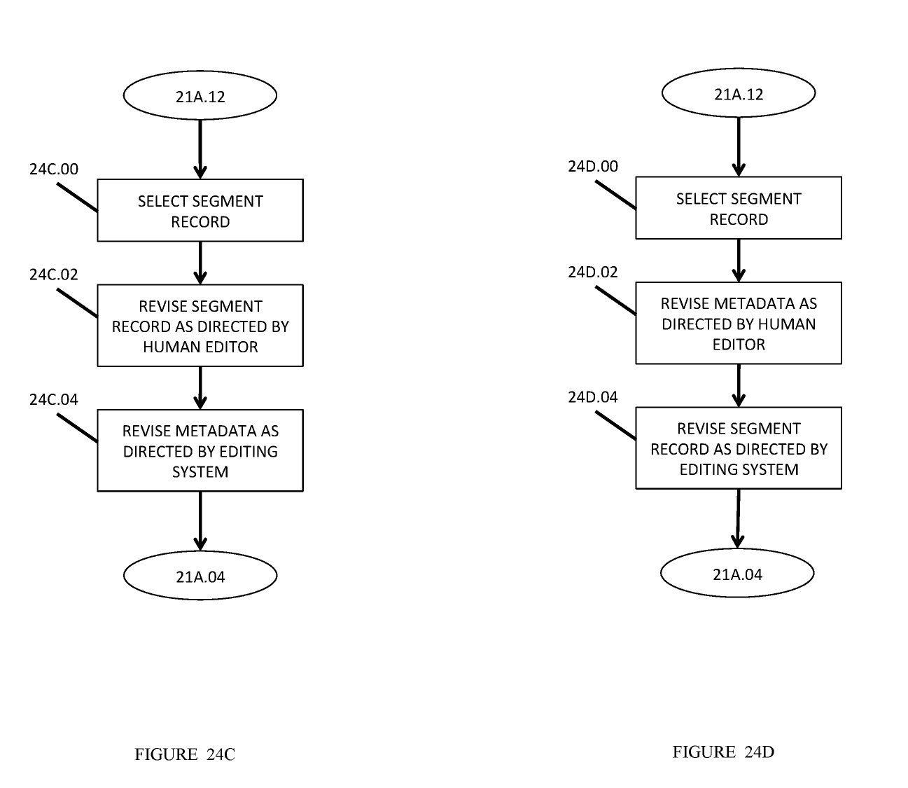

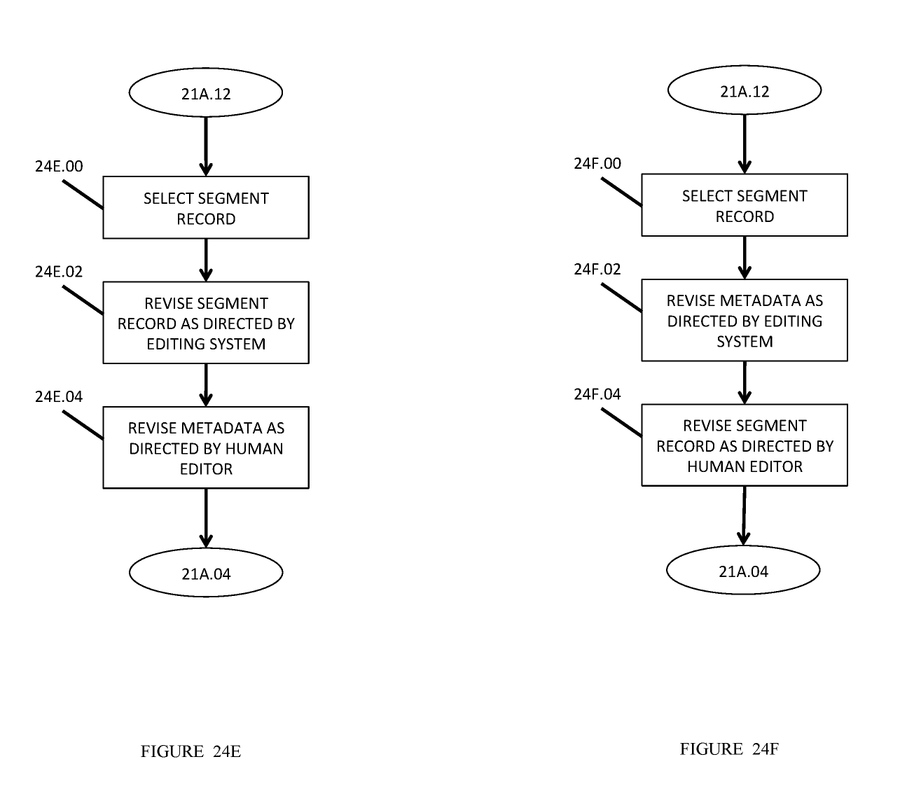

Referring now generally to the Figures, and particularly to FIG. 24A, FIG. 24A is a process chart of a further preferred embodiment of the invented method wherein a segment record SR.01-SR.N is revised by the human editor, and the metadata MD.01-MD.N is revised by the human editor. The human editor proceeds from step 21A.12 of the method of FIG. 21A to step 24A.00 of FIG. 24A. In step 24A.00 the human editor selects a segment record SR.01-SR.N for revision. In step 24A.02 the human editor revises one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. In step 24A.04 the human editor revises the metadata MD.01-MD.N to reflect the alterations made to the selected segment record SR.01-SR.N. The human editor subsequently proceeds to step 21A.04 of the method of FIG. 21A.

Referring now generally to the Figures, and particularly to FIG. 24B, FIG. 24B is a process chart of a yet further preferred embodiment of the invented method wherein metadata MD.01-MD.N is modified by a human editor, and a segment record SR.01-SR.N is subsequently revised by the human editor. The human editor proceeds from step 21B.12 of the method of FIG. 21B to step 24B.00 of FIG. 24B. In step 24B.00 the human editor selects a segment record SR.01-SR.N for revision. In step 24B.02 the human editor revises the metadata MD.01-MD.N. In step 24B.04 the human editor revises one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. The human editor subsequently proceeds to step 21B.04 of the method of FIG. 21B.

Referring now generally to the Figures, and particularly to FIG. 24C, FIG. 24C is a process chart of a yet additional preferred embodiment of the invented method wherein a segment record SR.01-SR.N is modified by a human editor, and the metadata MD.01-MD.N is revised by the editing system 200 as directed by the system software SW.5. The human editor proceeds from step 21A.12 of the method of FIG. 21A to step 24C.00 of FIG. 24C. In step 24C.00 the human editor selects a segment record SR.01-SR.N for revision. In step 24C.02 the human editor revises one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. In step 24C.04 the system software SW.5 enables the editing system 200 to revise the metadata MD.01-MD.N to reflect the alterations made to the selected segment record SR.01-SR.N. The human editor subsequently proceeds to step 21A.04 of the method of FIG. 21A.

Referring now generally to the Figures, and particularly to FIG. 24D, FIG. 24D is a process chart of a yet additional preferred embodiment of the invented method wherein metadata MD.01-MD.N is revised by a human editor, and a segment record SG.01-SG.N is revised by the editing system 200 as enabled by the system software SW.5. The human editor proceeds from step 21B.12 of the method of FIG. 21B to step 24D.00 of FIG. 24D. In step 24D.00 the human editor selects a segment record SR.01-SR.N for revision. In step 24D.02 the human editor revises the metadata MD.01-MD.N. In step 24D.04 the system software SW.5 directs the editing system 200 to revise one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. The human editor subsequently proceeds to step 21B.04 of the method of FIG. 21B.

Referring now generally to the Figures, and particularly to FIG. 24E, FIG. 24E is a process chart of an additional preferred embodiment of the invented method wherein a segment record SR.01-SR.N is modified by the editing system 200 as enabled by the system software SW.5 and the metadata MD.01-MD.N is revised by a human editor. The human editor proceeds from step 21A.12 of the method of FIG. 21A to step 24E.00 of FIG. 24E. In step 24E.00 the human editor selects a segment record SR.01-SR.N for revision. In step 24E.02 the system software SW.5 enables the editing system to revise one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. In step 24E.04 the human editor revises the metadata MD.01-MD.N to reflect the alterations made to the selected segment record SR.01-SR.N. The human editor subsequently proceeds to step 21A.04 of the method of FIG. 21A.

Referring now generally to the Figure, and particularly to FIG. 24F, FIG. 24F is a process chart of a further preferred embodiment of the invented method wherein metadata MD.01-MD.N is revised by the editing system 200 as enabled by the system software SW.5 and a segment record SR.01-SR.N is modified by the human editor. The human editor proceeds from step 21B.12 of the method of FIG. 21B to step 24F.00 of FIG. 24F. In step 24F.00 the human editor selects a segment record SR.01-SR.N for revision. In step 24F.02 the system software SW.4 enables the editing system 200 to revise the metadata MD.01-MD.N. In step 24F.04 the human editor revises one or all aspects of a segment record SR.01-SR.N, including but not limited to, the tags T.01-T.N, and/or the text segment SG.01-SG.N. Revision of the segment record SR.01-SR.N may optionally include deletion of the segment record SR.01-SR.N. The human editor subsequently proceeds to step 21B.04 of the method of FIG. 21B.

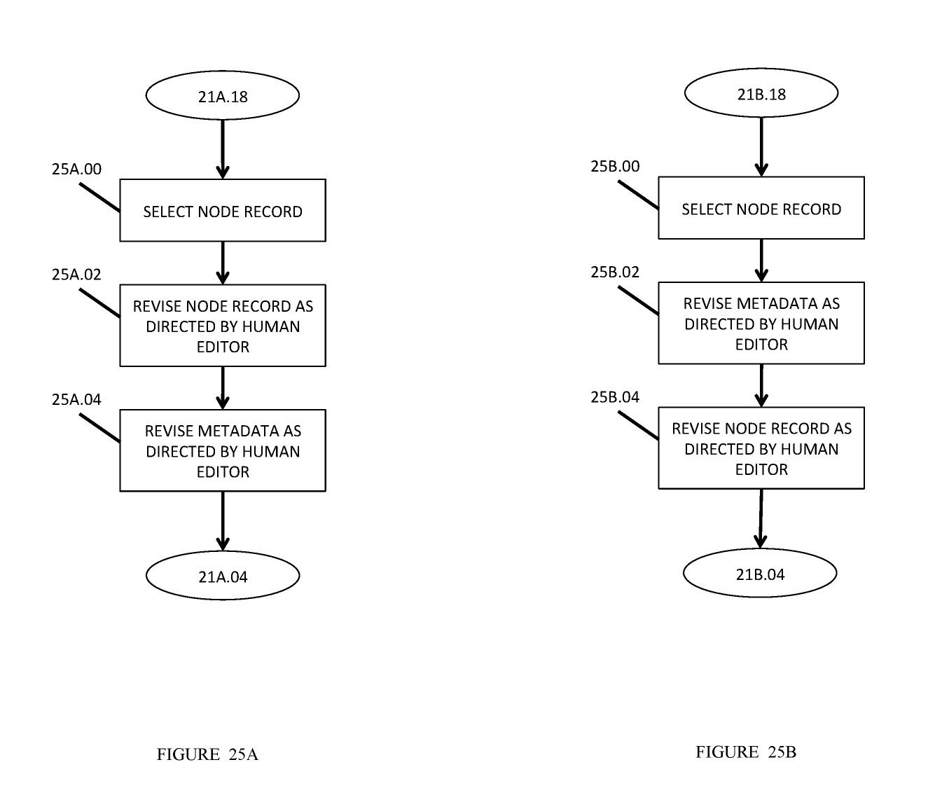

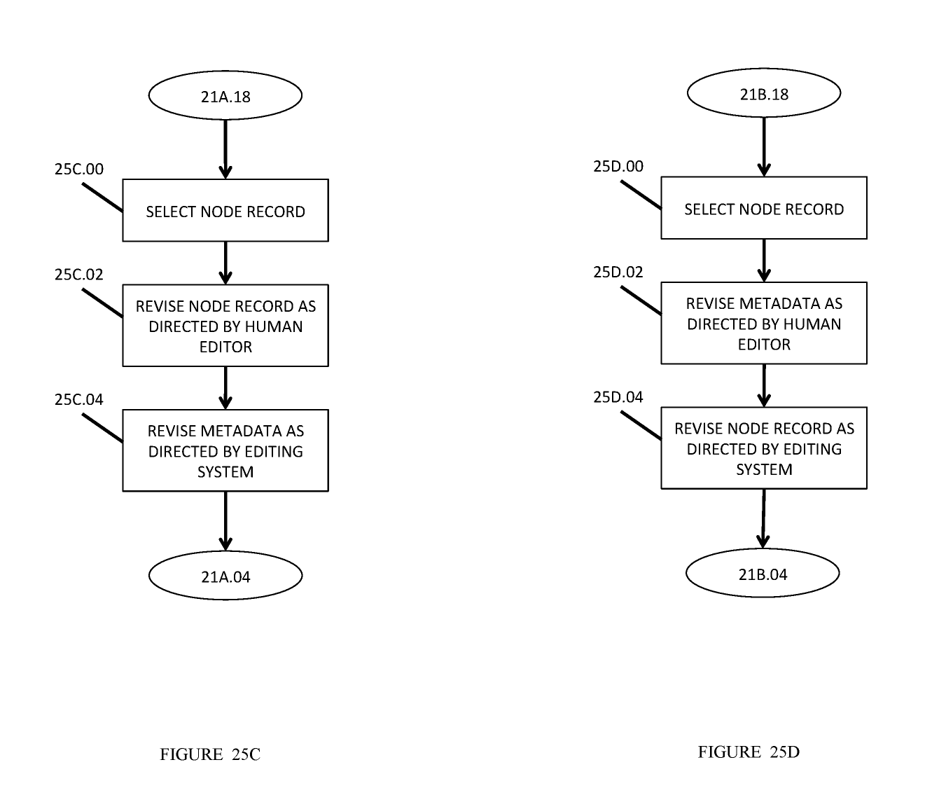

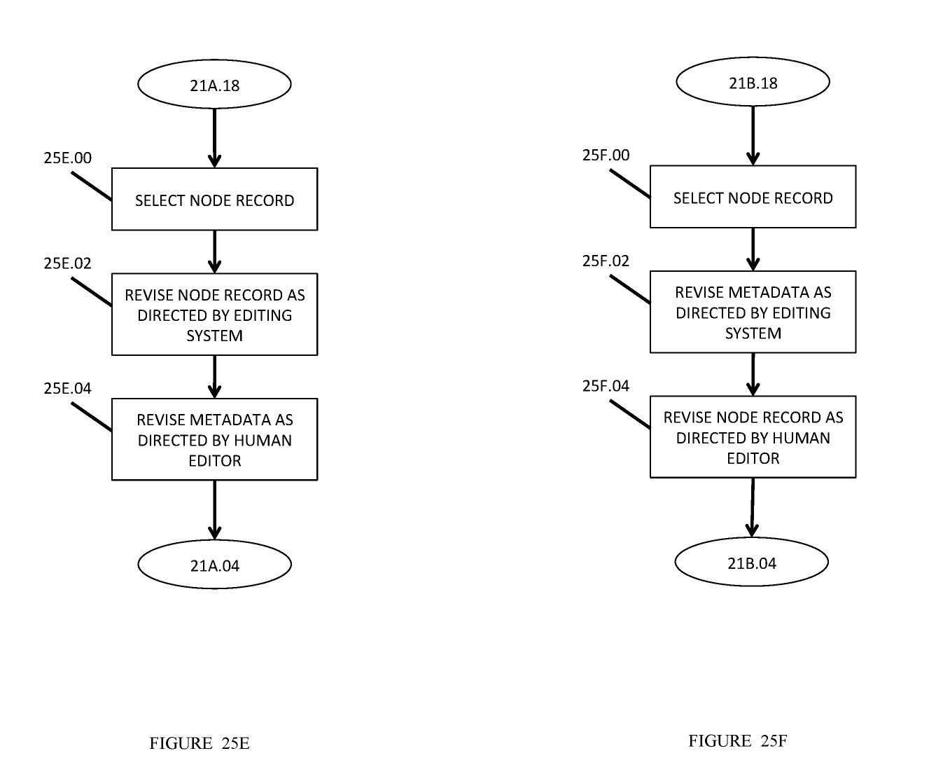

Referring now generally to the Figures, and particularly to FIG. 25A, FIG. 25A is a process chart of a further preferred embodiment of the invented method wherein a node record NR.01-NR.N is revised by a human editor, and metadata MD.01-MD.N is revised by a human editor. The human editor proceeds from step 21A.18 of the method of FIG. 21A to step 25A.00 of FIG. 25A. In step 25A.00 the human editor selects a node record NR.01-NR.N. In step 25A.02 the human editor revises one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N. Revision of the node record NR.01-NR.N may optionally include deletion of the node record NR.01-NR.N. The human editor subsequently revises the metadata MD.01-MD.N in response to the revision to the node record NR.01-NR.N in step 25A.04. The human editor then proceeds to step 21A.04 of FIG. 21A.

Referring now generally to the Figures, and particularly to FIG. 25B, FIG. 25B is a process chart of a yet further preferred embodiment of the invented method wherein metadata MD.01-MD.N is modified by a human editor, and a node record NR.01-NR.N is subsequently revised by a human editor. The human editor proceeds from step 21B.18 of the method of FIG. 21B to step 25B.00 of FIG. 25B. In step 25B.00 the human editor selects a node record NR.01-NR.N. In step 25B.02 the human editor revises the metadata MD.01-MD.N. In step 25B.04 the human editor revises one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N in response to the modification of the metadata MD.01-MD.N. Revision of the node record NR.01-NR.N may optionally include deletion of the node record NR.01-NR.N. The human editor then proceeds to step 21A.04 of FIG. 21A.

Referring now generally to the Figures, and particularly to FIG. 25C, FIG. 25C is a process chart of a yet additional preferred embodiment of the invented method wherein a node record NR.01-NR.N is modified by a human editor, and the metadata MD.01-MD.N is revised by the editing system 200 as directed by the system software SW.5. The human editor proceeds from step 21A.18 of the method of FIG. 21A to step 25C.00 of FIG. 25C. In step 25C.00 the human editor selects a node record NR.01-NR.N. In step 25C.02 the human editor revises one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N. Revision of the node record NR.01-NR.N may optionally include deletion of the node record NR.01-NR.N. The system software SW.5 directs the editing system to modify the metadata MD.01-MD.N in response to the revision to the node record NR.01-NR.N in step 25C.04. The human editor then proceeds to step 21A.04 of FIG. 21A.

Referring now generally to the Figures, and particularly to FIG. 25D, FIG. 25D is a process chart of a yet additional preferred embodiment of the invented method wherein metadata MD.01-MD.N is revised by a human editor, and a node record NR.01-NR.N is revised by the editing system 200 as directed by the system software SW.5. The human editor proceeds from step 21B.18 of the method of FIG. 21B to step 25D.00 of FIG. 25D. In step 25D.00 the human editor selects a node record NR.01-NR.N. In step 25D.02 the human editor revises the metadata MD.01-MD.N. In step 25D.04 the system software SW.5 directs the editing system 200 to modify one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N in response to the modification of the metadata MD.01-MD.N. Revision of the node record NR.01-NR.N may optionally include deletion of the node record NR.01-NR.N. The human editor then proceeds to step 21A.04 of FIG. 21A.

Referring now generally to the Figures, and particularly to FIG. 25E, FIG. 25E is a process chart of an additional preferred embodiment of the invented method wherein a node record NR.01-NR.N is modified by the editing system 200 as directed by the system software SW.5 and the metadata MD.01-MD.N is revised by a human editor. The human editor proceeds from step 21A.18 of the method of FIG. 21A to step 25E.00 of FIG. 25E. In step 25E.00 the human editor selects a node record NR.01-NR.N. In step 25E.02 the system software SW.5 directs the editing system 200 to revise one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N. Revision of the node record NR.01-NR.N may optionally include deletion of the node record NR.01-NR.N. The human editor modifies the metadata MD.01-MD.N in response to the revision to the node record NR.01-NR.N in step 25E.04. The human editor then proceeds to step 21A.04 of FIG. 21A.

Referring now generally to the Figures, and particularly to FIG. 25F, FIG. 25F is a process chart of a further preferred embodiment of the invented method wherein metadata MD.01-MD.N is revised by the editing system 200 as directed by the system software SW.5 and a node record NR.01-NR.N is modified by the human editor. The human editor proceeds from step 21B.18 of the method of FIG. 21B to step 25F.00 of FIG. 25F. In step 25F.00 the human editor selects a node record NR.01-NR.N. In step 25F.02 the system software SW.5 directs the editing system 200 to modify the metadata MD.01-MD.N. In step 25F.04 the human editor revises one or more aspects of the node record NR.01-NR.N, including, but not limited to a plurality of tag identifiers T.ID.01-T.ID.N; a plurality of alternate node record identifiers NR.ID.01-NR.01.N, and a plurality of segment record identifiers SR.ID.01-SR.ID.N; and/or one or more thread identifiers TH.ID.01-TH.ID.N in response to the modification of the metadata MD.01-MD.N. Revision of the node record NR.01-NR.N may optionally include deletion of the node record NR.01-NR.N. The human editor then proceeds to step 21A.04 of FIG. 21A.

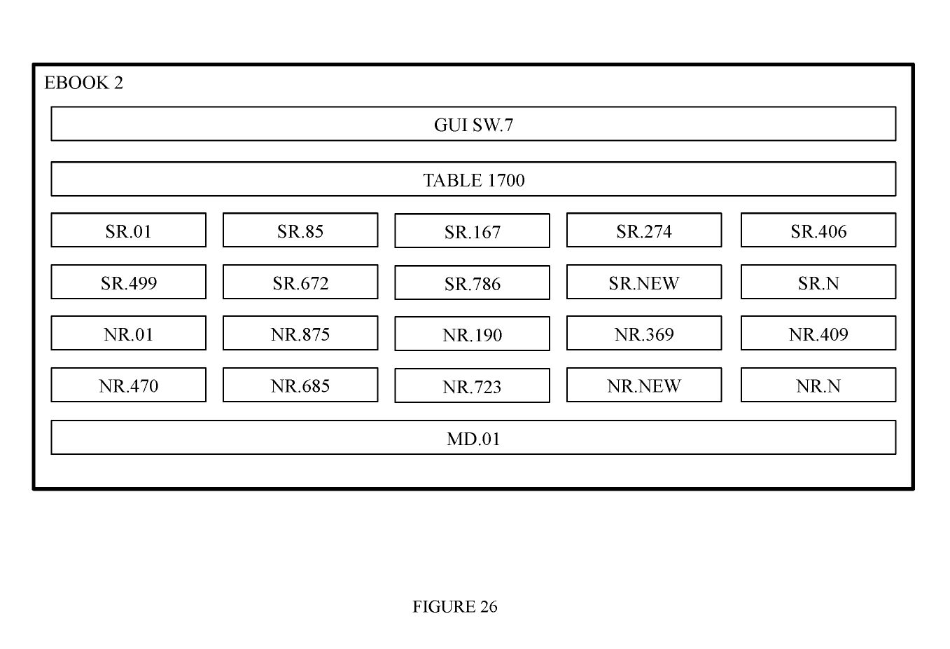

Referring now generally to the Figures FIG. 26 is a block diagram of the ebook 2, including a plurality of exemplary segment records SR.01-SR.N, a plurality of exemplary node records NR.01-NR.N, exemplary metadata MD.01, the table 1700, and the second GUI software SW.7.

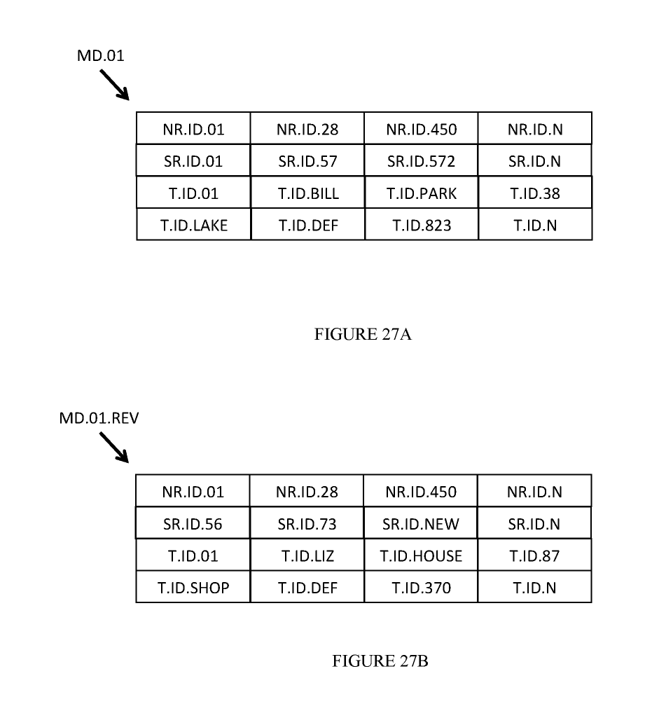

Referring now generally to the Figures, and particularly to FIG. 27A, FIG. 27A is a block diagram of exemplary metadata MD.01. The exemplary metadata MD.01 comprises a plurality of node record identifiers NR.ID.01-NR.ID.N, by which nodes ND.01-ND.N associated with text segments SG.001-SG.N and/or tags T.01-T.N may be identified within the system or by the human editor; a plurality of exemplary segment record identifiers SR.ID.01, SR.ID.57, SR.ID.572, and SR.ID.N; and a plurality of exemplary tags T.01, T.BILL, T.PARK, T.38, T.LAKE, T.DEF, T.823, and T.N.

Referring now generally to the Figures, and particularly to FIG. 27B, FIG. 27B is a block diagram is exemplary revised metadata MD.01.REV, wherein the exemplary revised metadata MD.01.REV has been modified in response to revision to the text segments SG.001-SG.N and/or the tags T.01-T.N by the human editor. The modifications to the metadata MD.01 may optionally be executed by the system, or by the human editor, and subsequently be recorded by the editing system. The revised metadata MD.01 comprises a plurality of node record identifiers ND.ID.01-ND.ID.N, a plurality of exemplary modified text segment identifiers SR.ID.56, SR.ID.73, SR.ID.920, and SR.ID.N; and a plurality of modified tags T.01, T.LIZ, T.HOUSE, T.87, T. SHOP, T.370, and T.N.

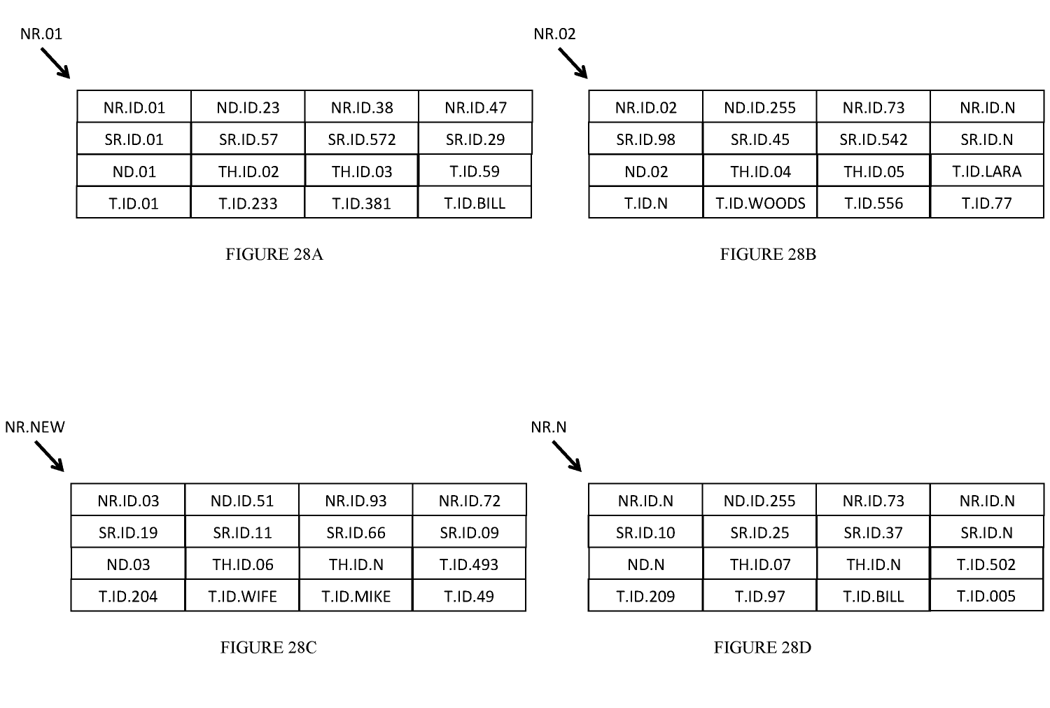

Referring now generally to the Figures, and particularly to FIGS. 28A-28D, FIGS. 28A-28D are block diagrams of exemplary node records NR.01-NR.N. Each exemplary node record NR.01-NR.N comprises a node record identifier NR.ID.01-NR.ID.N, by which the node record NR.01-NR.N may be identified; pointers to alternate node records NR.01-NR.N, whereby the node records NR.01-NR.N may be indicated as part of a series of nodes ND.01-ND.N; a node ND.01-ND.N; one or more thread identifiers TH.ID.01-TH.ID.N, by which narrative threads which the nodes ND.01-ND.N indicate may be identified by the system or by the human editor; and a plurality of tag identifiers T.ID.01-T.ID.N, and T.ID.BILL, T.ID.WOOD, T.ID.LARA, and T.ID.WIFE.

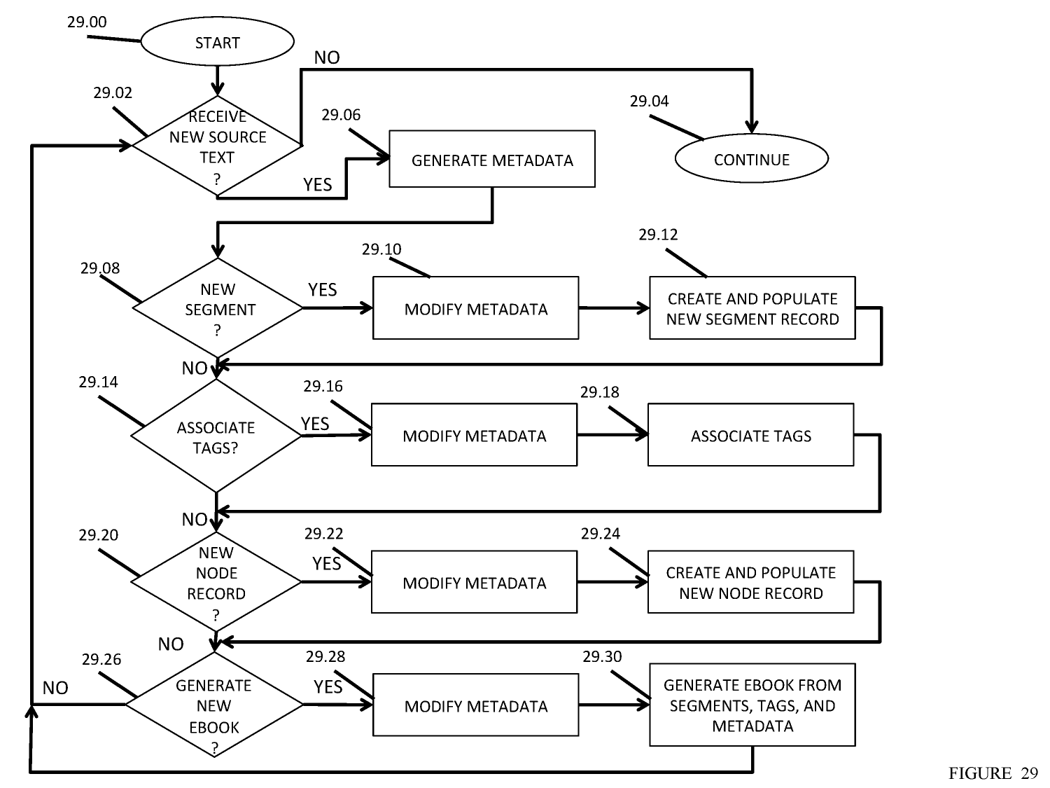

Referring now generally to the Figures, and particularly to FIG. 29, FIG. 29 is a flowchart of an additional preferred embodiment of the invented method wherein an ebook 2 is generated after a plurality of segments SG.01-SG.N, tags T.01-T.N, and metadata MD.01-MD.N describing the segments SG.01-SG.N and the tags T.01-T.N have been generated from a source text 100. The following method is preferably performed in its entirety by a human editor using a computing system, but may optionally be executed in part by means of an editing system 200. In step 29.02 it is determined whether a new source text 100 is received. When it is determined that no new source text has been received, alternate processes are executed in step 29.04. Alternately, when it is determined that a new source text 100 is received, metadata is generated in step 29.06. In step 29.08 it is determined whether to generate a new segment SG.01-SG.N. When it is determined in step 29.08 to generate a new segment SG.01-SG.N, the metadata MD.01-MD.N is modified in step 29.10, and a new segment record SR.01-SR.N is created and populated in step 29.12. Alternatively, when no new segment SG.01-SG.N is generated in step 29.08, it is determined in step 29.14 whether to associated tags T.01-T.N to the text. When it is determined in step 29.14 to associate tags T.01-T.N to the text, the metadata MD.01-MD.N is modified in step 29.16, and the tags T.01-T.N are associated in step 29.18. When it is determined in step 29.14 not to associate tags, the process advances to step 29.20. In step 29.20 it is determined whether to generate a new node record NR.01-NR.N. When it is determined to generate a new node record NR.01-NR.N in step 29.20, the metadata MD.01-MD.N is modified in step 29.22, and in step 29.24 a new node record NR.01-NR.N is created and populated. When, in the alternative, it is determined in step 29.20 not to generate a new node record NR.01-NR.N, it is determined in step 29.26 whether to generate a new ebook 2 from the segments SG.01-SG.N, tags T.01-T.N, and nodes ND.01-ND.N. When it is determined to generate a new ebook 2, the metadata is modified MD.01-MD.N, and the ebook 2 is generated based on the segments SG.01-SG.N, the tags T.01-T.N and the metadata MD.01-MD.N in step 29.30. The process subsequently returns to step 29.02 and re-executes the loop of steps 29.02 through 29.30 until in is determined in step 29.02 that no new source text has been received.

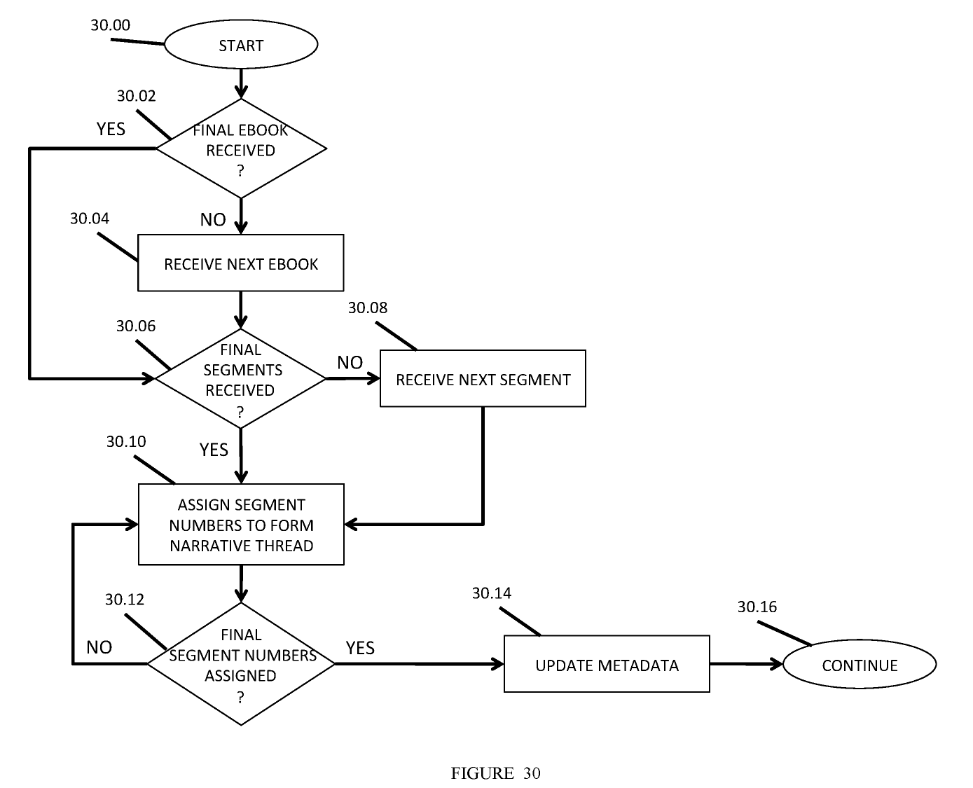

Referring now generally to the Figures, and particularly to FIG. 30, FIG. 30 is a flowchart of a yet additional preferred embodiment of the invented method wherein segments SG.01-SG.N from disparate ebooks 2 are associated, and unique segment number SEQ.01-SEQ.N are assigned to the segments SG.01-SG.N of the separate ebooks 2, which order the segments SG.01-SG.N according to a one-dimensional sequence, and the metadata MD.01-MD.N of each ebook 2 is updated to reflect the associations. In step 30.02 it is determined whether a final ebook 2, of at least two ebooks 2, has been received. When it is determined that no final ebook 2 has been received, a next ebook 2 is received in step 30.04. When a next ebook 2 has been received, or when it is determined in step 30.02 that a final ebook 2 has been received, it is determined in step 30.06 whether a final segment SG.01-SG.N has been received. When it is determined that no new segment SG.01-SG.N has been received, a next segment SG.01-SG.N is received or generated by a human editor or within the editing system 200. When a new segment SG.01-SG.N has been received in step 30.08, or when it is determined in step 30.06 that a final segment SG.01-SG.N has been received, the process advances to step 30.10. In step 30.10 individual segment numbers SEQ.001-SEQ.N are assigned to each of the segments SG.01-SG.N of each of the ebooks 2 in order for form a unified narrative thread TH.01-TH.N throughout the two or more books from which the segments SG.01-SG.N were derived, such that a user may navigate through and/or follow a thread TH.01-TH.N throughout several ebooks 2. In step 30.12 it is determined whether final segment numbers SEQ.001-SEQ.N have been assigned to segments SG.01-SG.N from the plurality of ebooks 2. When it is determined that the final segment numbers SEQ.001-SEQ.N have not been assigned to the segments SG.01-SG.N, the loop of steps 30.10 through 30.12 is executed as necessary. Alternately, when it is determined in step 30.12 that the final segment numbers SEQ.001-SEQ.N have been assigned, the metadata MD.01-MD.N of the ebooks 2 is updated in step 30.14. Alternate operations are executed in step 30.16.

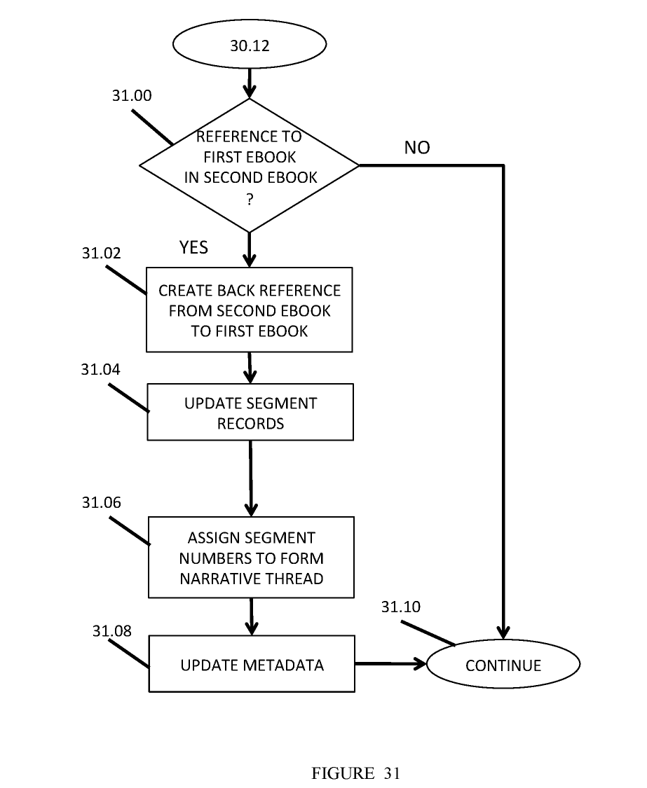

Referring now generally to the Figures, and particularly to FIG. 31, FIG. 31 is a flowchart of an aspect of the invented method wherein a back reference BR.01-BR.N to the first ebook 2A is added to the at least one other ebook 2B. Preferably a human editor, but optionally the editing system 200, proceeds from step 30.12 of the method of FIG. 30 to step 31.00, wherein it is determined whether a reference to a first ebook 2A is contained within a second ebook 2B. When it is determined that no reference to the first ebook 2A is contained within the second ebook 2B, alternate operations are executed in step 31.10. Alternately, When it is determined that a reference to the first ebook 2A is contained within the second ebook 2B, a back reference BR.01-BR.N from the second ebook 2B to the first ebook 2A is created. The back reference BR.01-BR.N is preferably a means by which a user may navigate to the first ebook 2A from the text of the second ebook 2B. In step 31.04 the segment records SR.01-SR.N are updated to reflect the back reference BR.01-BR.N from the second ebook 2B to the first ebook 2A. In step 31.06 segment numbers SEQ.001-SEQ.N are assigned to the segments SG.01-SG.N involved in the back reference BR.01-BR.N, such that the segment numbers SEQ.001-SEQ.N form a narrative thread TH.01-TH.N between the two ebooks 2. In step 31.08 the metadata MD.01-MD.N is updated, and alternate operations are executed in step 31.10.

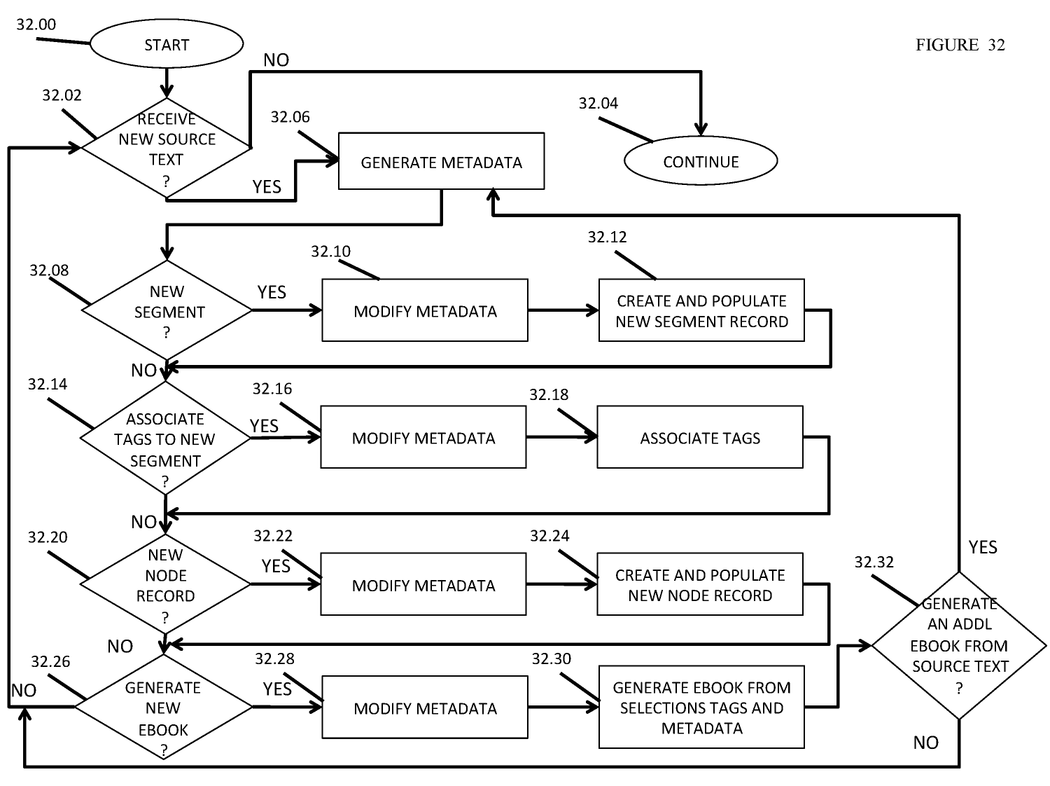

Referring now generally to the Figures, and particularly to FIG. 32, FIG. 32 is a flowchart of a preferred embodiment of the invented method wherein a plurality of ebooks 2 are generated from a single source text 100. The following method is preferably performed in its entirety by a human editor using a computing system, but may optionally be executed in part by means of an editing system 200. In step 32.02 it is determined whether a new source text 100 is received. When it is determined that no new source text has been received, alternate processes are executed in step 32.04. Alternately, when it is determined that a new source text 100 is received, metadata is generated in step 32.06. In step 32.08 it is determined whether to generate a new segment SG.01-SG.N. When it is determined in step 32.08 to generate a new segment SG.01-SG.N, the metadata MD.01-MD.N is modified in step 32.10, and a new segment record SR.01-SR.N is created and populated in step 32.12. Alternatively, when no new segment SG.01-SG.N is generated in step 32.08, it is determined in step 32.14 whether to associated tags T.01-T.N to the text. When it is determined in step 32.14 to associate tags T.01-T.N to the text, the metadata MD.01-MD.N is modified in step 32.16, and the tags T.01-T.N are associated in step 32.18. When it is determined in step 32.14 not to associate tags, the process advances to step 32.20. In step 32.20 it is determined whether to generate a new node record NR.01-NR.N. When it is determined to generate a new node record NR.01-NR.N in step 32.20, the metadata MD.01-MD.N is modified in step 32.22, and in step 32.24 a new node record NR.01-NR.N is created and populated. When, in the alternative, it is determined in step 32.20 not to generate a new node record NR.01-NR.N, it is determined in step 32.26 whether to generate a new ebook 2 from the segments SG.01-SG.N, tags T.01-T.N, and nodes ND.01-ND.N. When it is determined to generate a new ebook 2, the metadata is modified MD.01-MD.N, and the ebook 2 is generated based on the segments SG.01-SG.N, the tags T.01-T.N and the metadata MD.01-MD.N in step 32.30. In step 32.32 it is subsequently determined whether additional ebooks 2 may be generated from a source text 100. When it is determined that an additional ebook 2 may be generated from the source text 100, the human editor or the editing system 200 proceeds to step 32.06, wherein additional metadata MD.01-MD.N is generated to describe the additional ebook 2. Alternately, when it is determined that no additional ebook 2 may be generated from the source text 100, the process subsequently returns to step 32.02 and re-executes the loop of steps 32.02 through 32.30 until in is determined in step 32.02 that no new source text has been received.

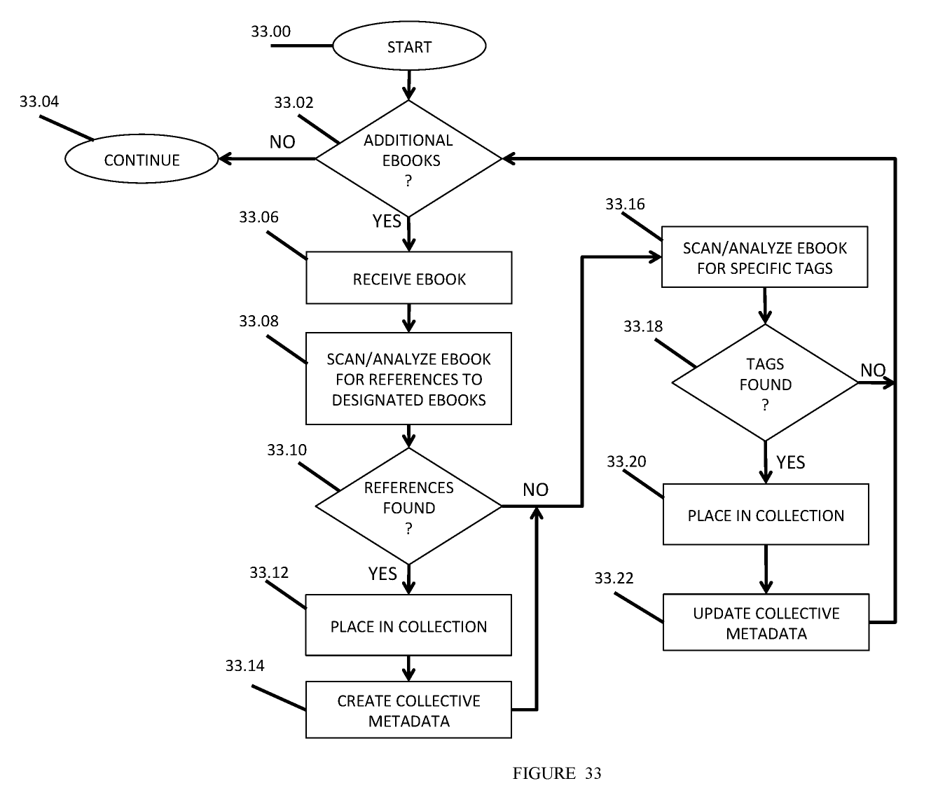

Referring now generally to the Figures, and particularly to FIG. 33, FIG. 33 is a flowchart of a yet further preferred embodiment wherein a plurality of ebooks 2 are placed within a collection CN.01-CN.N, and a collective metadata MD.C.01-MD.C.N is created to reflect the placement of the ebooks 2. In step 33.02 it is determined whether additional ebooks 2 are present which may be placed into a collection CN.01-CN.N. When it is determined that no additional ebooks 2 are present, alternate operations are executed in step 33.04. Alternately, when it is determined that additional ebooks 2 are present, an ebook 2 is received in step 33.06. In step 33.08 the ebook 2 is scanned and/or analyzed, preferably by the human editor, or optionally by the editing system 200, for references to additional designated ebooks 2. In step 33.10 it is determined whether references to additional designated ebooks 2 are found in the instant ebook 2. When it is determined that references to the additional designated ebooks 2 are found, the instant ebook 2 is placed into a collection CN.01-CN.N, wherein the collection CN.01-CN.N is preferably created by the human editor, and is designated based upon a plurality of traits which may be shared by several ebooks 2. In step 33.14 a collective metadata MD.C.01-MD.C.N is created for the purpose of description of the collection CN.01-CN.N of the ebooks 2.

Upon execution of step 33.14, or when it is determined in step 33.10 that no references to additional designated ebooks 2 may be found, step 33.16 is executed, wherein the ebook is scanned and/or analyzed for specific tags T.01-T.N which a plurality of ebooks 2 may share. The tags T.01-T.N may optionally be, but are not limited to, tags T.01-T.N describing genre, setting, character, author, subject matter, or any combination thereof. In a non-limiting example, a collection CN.01-CN.N may be directed toward gathering together books falling into the genre of mystery, and being set within the city of Chicago. The collections CN.01-CN.N may optionally be directed by a professor teaching a literature course, toward gothic and sentimental literature. In step 33.18 it is determined whether the desired tags T.01-T.N were found in the instant ebook 2. When it is determined that the tags T.01-T.N are not present in the instant ebook 2, the process proceeds to step 33.02. Alternately, when it is determined in step 33.18 that the desired tags T.01-T.N may be found in the ebook 2, the ebook 2 is placed in the collection CN.01-CN.N by the human editor in step 33.20. In step 33.22 the collective metadata MD.C.01-MD.C.N is updated to reflect the inclusion of the ebook 2 in the collection CN.01-CN.N. Subsequently, the loop of steps 33.02 through 33.22 is repeated as necessary.

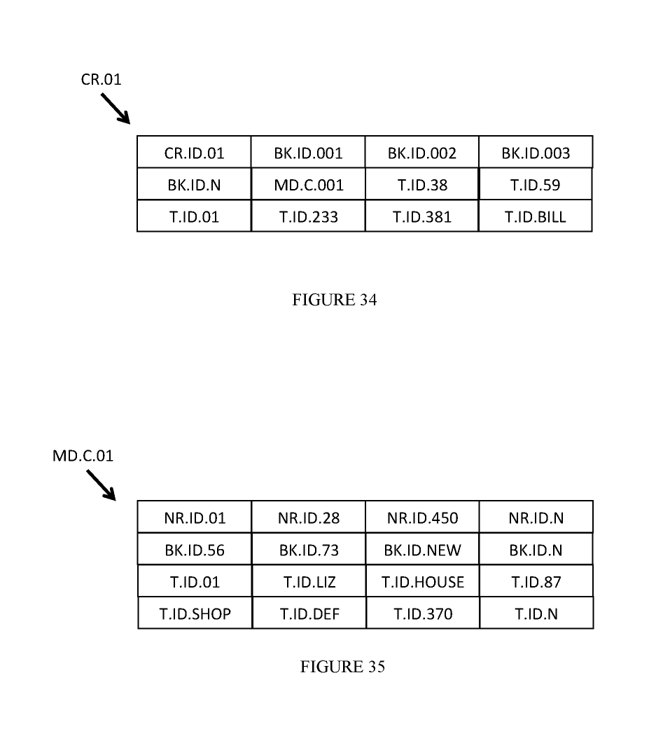

Referring now to the Figures, and particularly to FIG. 34, FIG. 34 is a block diagram of a first exemplary collection record CR.01 having collective metadata MD.C.01. The first exemplary collection record CR.01 includes a first collection record identifier CR.ID.01, a plurality of ebook 2 identifiers BK.ID.01-BK.ID.N, the collective metadata MD.C.01, and a plurality of tags identifiers T.ID.38, T.ID.59, T.ID.01, T.ID.233, T.ID.381, T.ID.BILL describing the desired traits of the ebooks 2 for the collection.

Referring now to the Figures, and particularly to FIG. 35, FIG. 35 is a block diagram of exemplary collective metadata MD.C.01. The exemplary collective metadata MD.C.01 includes a plurality of node record identifiers NR.ID.01-NR.ID.N, a plurality of ebook 2 identifiers BK.ID.56, BK.ID.73, BK.ID.NEW, and BK.ID.N; and a plurality of tag identifiers T.ID.01, T.ID.LIZ, T.ID.HOUSE, T.ID.87, T.ID.SHOP, T.ID.DEF, T.ID.370, and T.ID.N.

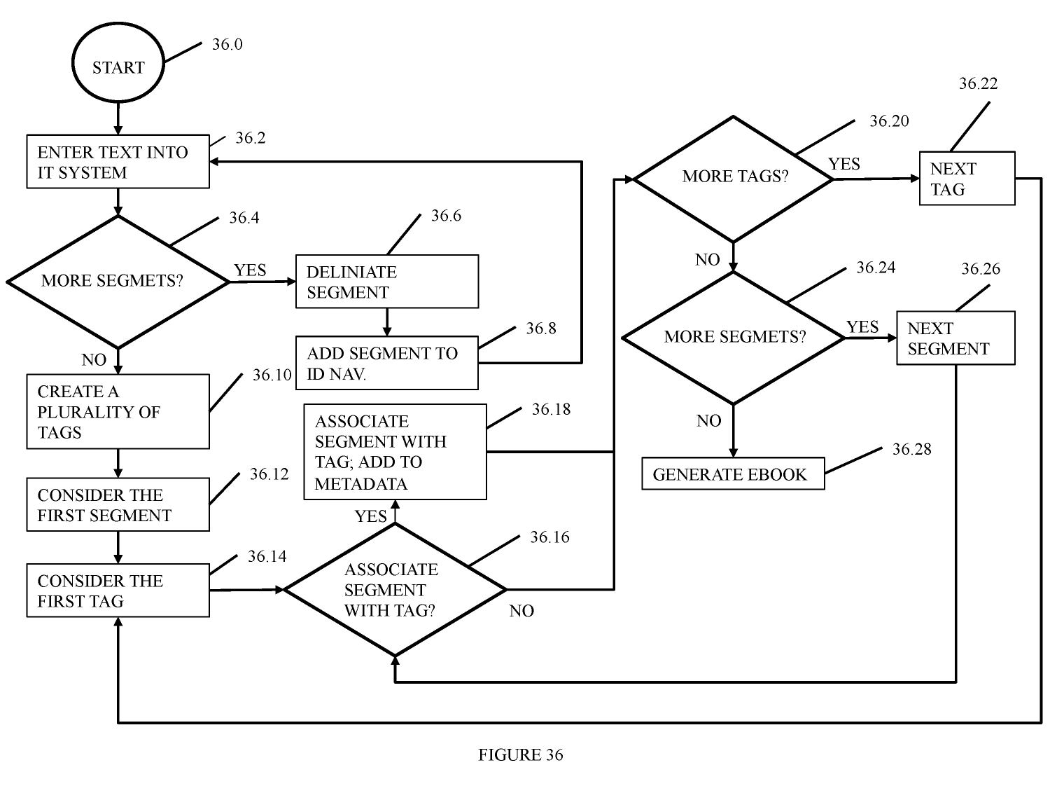

Referring now to the Figures, and particularly to FIG. 36, FIG. 36 is a flowchart of yet another preferred embodiment wherein a digital text 100 such as the ebook 2 is created by a human editor by the text 100 first being divided into segment SG.01-SG.N, and these segment SG.01-SG.N are further associated with IDs for an ID-based navigation as well as being associated with tags T.01-T.N to create a navigation method where segment SG.01-SG.N can be navigated to if they share tags T.01-T.N either directly or via an intermediate step where all segment SG.01-SG.N associated with a tag can be displayed and can be selected from. In step 36.02, single source text 100 is entered into the editing system 200 in its entirety by one or more human editors. If more segments SG.01-SG.N are determined to exist in step 36,04, a new segment SG.01-SG.N is delineated within the editing system 200 as directed by the human editor in step 36.06 and added to the ID NAV in step 36.08. In an alternate outcome of step 36.04, where no more segment SG.0I-SG.N are directed to be formed by editing system 200 as directed by the human editor, a plurality of tags T.01-T.N is then created in step 36.10. In 36.04 through 36.08, the text 100 is divided into segment SG.0I-SG.N the editing system 200 as directed by the human editor, and these segments SG.01-SG.N are assigned Ms and associated with an ID-based navigation system 200. In 36.10 a plurality of tags T.01-T.N are established the editing system 200 as directed by the human editor by either manually or via an automatic process of either establishing boilerplate and culling from use or some other either automatic or manual procedure. The first segment of SG.01-SG.N is then considered in step 36.12 leading into the consideration of the first tag in step 36.14. Step 36.16 commences the associative evaluation operationally conducted by the editing system 200 as directed by the human editor with tag to segment SG.01-SG.N. If an appropriate tag exists, then in step 36.18, the tag is added to the metadata MD.01-MD.N. An alternate outcome of step 36.16 is where a relevant tag does not exist, here the data is processed by the editing system 200 as directed by the human editor in attempt to find more available tags T.01-T.N in step 36.20. If more tags T.01-T.N are found in step 36.20, then in step 36.22 the next tag is considered, and attention of editor or system 200 is the editing system 200 as directed by the human editor proceeds to step 36.14. The other outcome of step 36.20 is where there are no more tags T.01-T.N. When there are no more tags T.01-T.N available for step 36.20 more segment SG.01-SG.N are considered in the next step, the editing system 200 proceeds on to step 36.24. If more segments SG.01-SG.N are found in step 36.2.4 the next segment SG.01-SG.N is considered in step 36.26 and the editing system 200 as directed by the human editor returns to step 36,16 to determine if there is a tag associated with the segment SG.01-SG.N. The alternate outcome of step 36.2.4 is where no more segment SG.01-SG.N are available, in this scenario the ebook 2 is then generated in step 36.28. In steps 36.12 through 36.26, all juxtapositions of individual segment SG.01-SG.N and tags T.01-T.N are considered and either the segment SG.01-SG.N in question is associated with the tag in question or it is not.

It is understood that although the flowchart describes a process where all tags T.01-T.N are considered for a given segment SG.01-SG.N before moving on to the next segment SG.01-SG.N, the editing system 200 as directed by the human editor as intended to be described by this preferred embodiment might instead consider all segment SG.01-SG.N for a given tag before proceeding to the next tag, or allow the editor to freely associate segment SG.01-SG.N and tags T.01-T.N by choosing either a segment SG.01-SG.N to associate with a tag via the ID-based navigation system 200 or to associate a segment SG.01-SG.N with a tag by choosing from a list of tags T.01-T.N. Also, the method of FIG. 6 doesn't preclude associations being created by automated means such as automatic word searches, and these means may be either fully automated or manually post-processed. In 36.28, ultimately, the segment SG.01-SG.N, their Ms, the ID-based navigation system of the method of FIG. 36, the tags T.01-T.N, and the metadata MD.01-MD.N associating tags T.01-T.N with segment SG.01-SG.N and vice versa are all used to generate the ebook 2 where the human reader can use the created associations to navigate the ebook 2 and uncover associations and depth in the digital text 100 that might otherwise go unnoticed and produce reader experiences not possible to generate by prior art means.

One skilled in the art will recognize that the foregoing examples are not to be taken in a limiting sense and are simply illustrative of at least some of the aspects of the present invention.

What is claimed is:

1. A method comprising:
entering a source digitized text into a memory of an information technology system;
delineating the source by a human editor into a first plurality of segments (“segments”);
ordering the Segments using unique identifiers (“segment IDs”);
associating by the human editor of a second plurality of the segments with at least one navigation tag of a plurality of navigation tags;
enabling an eBook user to navigate among Segments using segment IDs;
a human editor creating a plurality of category tags;
the human editor associating each segment of a plurality of the segments to one or more of a plurality of tags;
generating a metadata, the metadata specifying at least one segment of the segments and at least one association of the at least one navigation tag of the plurality of navigation tags with the at least one segment; and
generating an ebook, the ebook comprising the segments, segment ID's, indications of associations of segments and tags, and the metadata.

2. The method of claim 1, wherein generating the metadata further comprises specifying in the metadata a first plurality of the segments and associations of navigation tags of the plurality of navigation tags with at least one segment.

3. The method of claim 3, wherein generating the metadata further comprises specifying in the metadata a plurality of associations of the navigation tags of the plurality of navigation tags with the first plurality of the segments.

4. The method of claim 1, further comprising accepting additional source digitized data:
accepting an additional source digitized text;
delineating the additional source digitized data by a second human editor into at least one new segment (“new segment”); and
modifying the one-dimensional sequence of the segments to include a positioning of the new segment within the one-dimensional sequence of the segments.

5. The method of claim 4, further comprising revising the metadata to reference the new segment.

6. The method of claim 5, wherein revising the metadata further comprises specifying in the metadata at least one navigation tag with the new segment.

7. The method of claim 4, further comprising revising the metadata to specify an additional association of the new segment with a second navigation tag of the plurality of navigation tags.

8. A method of generating an association of a plurality of ebooks, the method comprising:
receiving a plurality of source digitized texts;
applying the method of claim 1 to generate a plurality of ebooks, each ebook delineated as comprising a metadata and a plurality of associated segments; and
a human editor adding a reference within a first ebook to at least one other ebook.

9. The method of claim 8, wherein the reference to the at least one other ebook comprises a navigation tag indicator.

10. The method of claim 8, wherein the reference is added to a first segment of the first ebook.

11. The method of claim 8, wherein the reference is added to a first metadata of the first ebook.

12. The method of claim 8, wherein a back reference to the first ebook is added to the at least one other ebook.

13. The method of claim 12, wherein the back reference is added to an indicated segment of the at least one other ebook.

14. The method of claim 12, wherein the at least one other ebook comprises a second metadata and the back reference is added to the second metadata.

15. The method of claim 12, wherein the back reference indicates a segment of the first ebook.

16. The method of claim 12, wherein the back reference indicates the first segment of the first ebook.

17. A method comprising:
generating a plurality of ebooks, each ebook comprising a plurality of segments and a metadata internally associating the plurality of segments within each comprising ebook: and
associating the plurality of ebooks as a collection by means of a collective metadata.

18. The method of claim 17, further comprising associating a first segment of a first ebook of the plurality of ebooks with a second ebook of the plurality of ebooks.

19. The method of claim 18, further comprising
rendering the first segment of the first ebook; and
responsive to a user command, rendering an additional segment of the second ebook.

20. The method of claim 18, wherein the association of the first segment of the first ebook with the second ebook comprises associating the first segment with a second segment of the second ebook.

21. A method comprising:
entering a source digitized text (“Text”) into a memory of an information technology system;
a human editor dividing the Text into a plurality of segments (“Segments”);
ordering the Segments using unique identifiers (“Segment IDs”);
enabling an eBook user to navigate among Segments using Segment IDs;
a human editor creating a plurality of category tags (“Tags”);
the human editor associating a subset of the Segments to each Tag;
generating a metadata collection (“Metadata”) for each Tag comprising collections of Segments associated with that Tag; and
in each Metadata, ordering the Segments using unique identifiers (“Metadata IDs”);
enabling an eBook user to navigate among Segments using Metadata IDs.
